(19) United States
(12) Patent Application Publication
(10) Pub. No.: US 2011/0179066 A1
(43) Pub. Date: Jul. 21, 2011

(54) METHODS, APPARATUS AND SYSTEMS FOR DATA VISUALIZATION AND RELATED APPLICATIONS

(75) Inventors: Andrew John Cardno, San Diego, CA (US); Peter Stewart Ingham, Avalon (NZ); Bart Andrew Lewin, Woodland Hills, CA (US); Ashok Kumar Singh, Henderson, NV (US)

(73) Assignee: Business Intelligence Solutions Safe B.V., Amsterdam (NL)

(21) Appl. No.: 13/000,267

(22) PCT Filed: Jun. 18, 2009
(86) PCT No.: PCT/NZ2009/000113

§ 371 Date: Mar. 30, 2011

Related U.S. Application Data
(60) Provisional application No. 61/074,347, filed on Jun. 20, 2008.
(60) Provisional application No. 61/101,670, filed on Sep. 30, 2008.

(51) Int. Cl. G06F 17/30

(52) U.S. Cl. 707/769; 707/705; 707/E17.045; 707/E17.014

(57) ABSTRACT

In a graphical analysis computing system, a method of arranging data sets for graphical analysis, wherein at least two of the data sets have different periodicities, the method comprising the steps of: a data retrieval module retrieving data from a data storage module in communication with the graphical analysis computing system; a periodicity determination module determining a plurality of periodicities within the retrieved data to identify a plurality of data sets based on the determined periodicities; and an alignment module aligning a first identified data set of a first periodicity relative to a second identified data set of a second periodicity, wherein the second periodicity is different to the first periodicity.

### FIELD OF THE INVENTION

The present invention relates to methods, apparatus and systems for temporal data visualization and related applications.

### BACKGROUND

A chart or graph is described in Wikipedia as a type of information graphic or graphic organizer that represents tabular numeric data and/or functions. Charts are often used to make it easier to understand large quantities of data and the relationship between different parts of the data. Charts can usually be read more quickly than the raw data that they come from. They are used in a wide variety of fields, and can be created by hand (often on graph paper) or by computer using a charting application.

Traditional charts use well established and often poorly implemented ways of representing data. Many tools exist to help the user construct very sophisticated representations of data but that sophistication typically results in less meaningful charts. Embodiments of the present invention aim to overcome this problem.

It is known to use charting wizards such as those that are available in Excel and various other systems such as those provided by, for example, IBM. In addition there are multiple Business Intelligence (BI) tools available to users to enable users to analyze data in an attempt to create meaningful feedback. However, as the amount of data increases, so does the complexity of the visual representations created by the analysis of the data. These complex representations can end up swamping parts of the visual representation that is most required and relevant to an end user.

In addition, known systems provide a standardized list of options to all users which the user then must wade through and try and determine which of the options available are most suitable for representing their particular data. This can result in the user mismatching the data being represented with the chosen visual representation so that the resultant representation does not clearly, accurately and succinctly identify any issues with, or convey information about, the data. This can result in the user missing particularly important features of the data due to those features not being represented in the most appropriate manner.

Also, although there are many sophisticated visualization algorithms that do exist and are being developed for specific functions, these algorithms are not provided to a user in a manner that guides the user to easily pick the data to be represented, pick the correct summaries of the data, pick the right dimensions to be represented, pick the right forms of visual representation, or choose unique visual designs to create a collection of visualizations that help someone run their business.

Further, the focus of existing known methods is on providing a single visual design, or type of visual or graphical representation, to represent data. That is, to produce, for example, a single bar graph to be displayed, or a single pie chart to be printed. This is very limiting to a user who may want to show various different aspects of the data in a single document.

Business measures are a well known means of identifying a manageable number of algorithms for which to run a business. However, these business measures merely represent a single dimension of the data, or even only a single number, and so are particularly limiting in respect of the data that they represent. Further, the business measures merely represent data and do not include any further functional capabilities.

Various other references to the prior art and its associated problems are made throughout the following description.

The present invention aims to overcome, or at least alleviate, some or all of the mentioned problems, or to at least provide the public with a useful choice.

### SUMMARY OF THE INVENTION

Various concepts are herein disclosed as set out in the claims at the end of the specification.

### BRIEF DESCRIPTION OF THE DRAWINGS

Embodiments of the present invention will now be described, by way of example only, with reference to the accompanying drawings, in which:

FIG. 1A shows a NASDAQ Heat Map Example;

FIG. 1B shows a NASDAQ Heat Map Intra Day Data Example;

FIG. 1C shows a diagrammatical representation of some key terms;

FIG. 2A shows a system concept diagram according to an embodiment of the present invention;

FIG. 2B shows an overview of the software modules in the described system.

FIG. 3 shows a general overview of the data flow within the system according to an embodiment of the present invention;

FIG. 4 shows an architectural overview of the described solution according to an embodiment of the present invention;

FIG. 5 shows a high-level system delivery overview of the described solution according to an embodiment of the present invention;

FIG. 6A shows a general data flow diagram according to an embodiment of the present invention;

FIG. 6B shows a flow diagram according to an embodiment of the present invention;

FIG. 7 shows the concept of layers according to an embodiment of the present invention;

FIG. 8A shows the alignment of data sets with different periods according to an embodiment of the present invention;

FIG. 8B shows a dodecagon spiral according to an embodiment of the present invention;

FIG. 8C shows a box spiral according to an embodiment of the present invention;

FIG. 8D shows a further dodecagon spiral according to an embodiment of the present invention;

FIG. 8E shows a conceptual diagram of aligning data sets with differing periodicities according to an embodiment of the present invention;

FIG. 8F shows a known method of graphically representing data points;

FIG. 8G shows a method of graphically representing data points according to an embodiment of the present invention;

FIG. 8H shows a conceptual diagram of aligning periodic events according to an embodiment of the present invention;

FIG. 8I shows a method of adjusting data according to an embodiment of the present invention;

FIG. 8J shows a further method of adjusting data according to an embodiment of the present invention;

FIG. 8K shows a further method of adjusting data according to an embodiment of the present invention;

FIG. 9 shows a conceptual system diagram of a graphical analysis computing system according to an embodiment of the present invention;

FIG. 10 shows a flow diagram according to an embodiment of the present invention;

FIG. 11 shows a temporal query system according to an embodiment of the present invention;

FIG. 12 shows a flow diagram according to an embodiment of the present invention;

FIG. 13 shows how embodiments of the present invention may be incorporated within a gaming environment;

### DETAILED DESCRIPTION OF THE INVENTION

The following described invention is suitable for use in conjunction with other methods, and the incorporation into one or more systems, for example as described in METHODS, APPARATUS AND SYSTEMS FOR DATA VISUALISATION AND RELATED APPLICATIONS (earlier filed by the applicant in the entirety as U.S. provisional patent application Ser. No. 61/074,347 filed on 20 Jun. 2008), and incorporated by reference, a portion of which herein follows.

Four key terms (or concepts) form the foundation of the specification set out in this document and accordingly have been defined as follows:

The four key terms are:

### Business Performance Drivers (BPD)

### BPD Packages

### Visual Designs

### Visual Documents

The key terms are defined as follows:

Business Performance Drivers (BPDs): A Business Performance Driver (BPD) is a business metric used to quantify a business objective. For example, turnover, sales. BPDs are Facts (sometimes referred to as measures). Facts are data items that can be counted. For example, Gross Sales; Units Sold. BPDs comprise of:
1. Measures: Data items that can be counted. For example, Gross Sales; Units Sold.
2. Dimensions: Data items that can be categorized. For example, Gender; Locations.
3. Restrictions can be applied to BPDs. These filter the data included. For example a restriction of ‘State=“CA”’ may be specified to only include data for California.
4. Normalizations can be applied to BPDs. These specify (or alter) the time period the BPD refers to. For example—Daily Units Sold, Monthly Profit. The combination of BPDs, Restrictions and Normalizations provides the flexibility to create many ways of looking at data without requiring extensive definition effort.

In other words a Business Performance Driver (BPD) is a ‘measure’ that can be normalized. Measures are data items that can be counted. For example, Gross Sales; Units Sold. BPDs might be displayed on visualizations. For example, Revenue earned per store on a map. Restrictions and/or Normalizations could be applied to a BPD. The following table provides examples of these:

| Scenario | Business Example |
|---|---|
| BPD (no | Revenue |
| normalization | |
| or restriction) | |
| BPD with | Revenue earned in the state of California |
| restriction | |
| BPD with | Revenue earned in week 1 of 2008 |
| normalization | |
| BPD with | Revenue earned in the state of California in week 1 of |
| restriction and | 2008 |
| normalization | |

BPD Packages: A BPD Package is made up from a set of related BPDs. This relationship (between a BPD Package and its BPDs) is defined using metadata. BPD Packages can be thought of as the Visual Document's vocabulary.

Visual Designs: Visual Designs are a classification of the different types of visualizations that a user may choose. Within each Visual Design, there are a number of visualizations. For example, the ‘spatial’ category can have retail store location maps or geographical location maps. The software solution allows users to select one visualization (one visual form within a Visual Design category) to create a Visual Document.

Visual Document: A Visual Document contains visual representations of data. Access to the data used to construct the visual representation is in many ways analogous to a textual document. A Visual Document is constructed by applying BPD data to a specific Visual Design. It is designed to illustrate at least one specific point (using the visualization), supports the points made with empirical evidence, and may be extended to provide recommendations based on the points made. The Visual Document is a deliverable to the user.

| Dimensions | Dimensions are data items that can be categorized. For | | | |
|---|---|---|---|---|
| | example, Gender; Locations. | | | |
| | Dimensions might be displayed on visualizations. For | | | |
| | example product categories on a shop floor. | | | |
| Fact | See Business Performance Drivers (BPDs) | | | |
| Measure | See Business Performance Drivers (BPDs) | | | |
| Normalizations | Can be applied to BPDs. These specify (or alter) the | | | |
| | time period the BPD refers to. For example - Daily | | | |
| | Units Sold, Monthly Profit. | | | |
| | The combination of BPDs, Restrictions and | | | |
| | Normalizations provides the flexibility to create many | | | |
| | ways of looking at data without requiring extensive | | | |
| | definition effort. Refer to definition of BPDs for | | | |
| | examples. | | | |
| Restrictions | Can be applied to BPDs or Dimensions. These filter the | | | |
| | data included. For example a restriction of ‘State = | | | |
| | “CA”’ may be specified to only include data for | | | |
| | California. | | | |
| | A BPD or Dimension could be restricted by Compound | | | |
| | Statements (series of restrictions using AND/OR | | | |
| | statements). For example, Revenue from all stores | | | |
| | where state = California AND units sold >200units. | | | |
| | Restrictions have the following types: | | | |
| | Restriction | | | Business |
| | Type | Definition | Example | Context |
| | = | Equal to | State = | Revenue |
| | | | ‘CA’ | earned |
| | | | | within the |
| | | | | state of |
| | | | | California |
| | >= | Greater | Units Sold | Revenue |
| | | than or | >=200 | earned from |
| | | equal to | | stores where |
| | | | | units sold |
| | | | | were greater |
| | | | | than (or |
| | | | | equal to) 200 |
| | | | | units |
| | =< | Less than | Revenue | Revenue |
| | | or equal to | =<$50,000 | earned from |
| | | | | stores where |
| | | | | Revenue was |
| | | | | less than (or |
| | | | | equal to) |
| | | | | $50,000 |
| | > | Greater | Units Sold | Revenue |
| | | than | >200 | earned from |
| | | | | stores where |
| | | | | the number |
| | | | | of units sold |
| | | | | were greater |
| | | | | than |
| | | | | 200units |
| | < | Less than | Units Sold | Revenue |
| | | | <200 | earned from |
| | | | | stores where |
| | | | | the number |
| | | | | of units sold |
| | | | | were less |
| | | | | than |
| | | | | 200units |
| | IN | In (list) | State IN | Revenue |
| | | | (‘CA’, | earned from |
| | | | ‘NY’) | stores within |
| | | | | the states of |
| | | | | California |
| | | | | and New |
| | | | | York |
| | BETWEEN | Values | Product | Revenue |
| | | between X | Code | earned from |
| | | and Y | between | product |
| | | | ‘124’ and | codes 124 to |
| | | | ‘256’ | 256 |
| | | | | (inclusive) |
| | NOT= | Not Equal | State NOT = | Revenue |
| | | to | CA | earned from |
| | | | | stores |
| | | | | outside the |
| | | | | state of |
| | | | | California. |
| | NOT IN | Not in | State NOT | Revenue |
| | | (list) | IN (‘CA’, | earned from |
| | | | ‘NY’) | outside the |
| | | | | states of |
| | | | | California |
| | | | | and New |
| | | | | York. |
| | NOT | Values not | Store | Revenue |
| | BETWEEN | between X | Code | earned from |
| | | and Y | NOT | stores |
| | | | Between | excluding |
| | | | 105 and | stores with a |
| | | | 110 | store code |
| | | | | between 105 |
| | | | | and 110 |
| | | | | (inclusive). |

Heat maps: A heat map is a graphical representation of data where the values taken by a variable in a two-dimensional map are represented as colors. A very similar presentation form is a Tree map.

Heat maps are typically used in Molecular Biology to represent the level of expression of many genes across a number of comparable samples (e.g. cells in different states, samples from different patients) as they are obtained from DNA microarrays.

Heat maps are also used in places where the data is volatile and representation of this data as a heat map improves usability. For example, NASDAQ uses heat maps to show the NASDAQ-100 index volatility. Source: Wikipediaⁱ

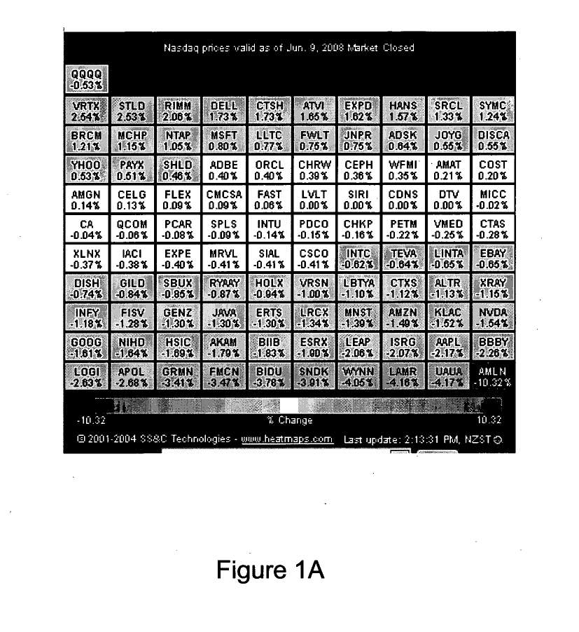

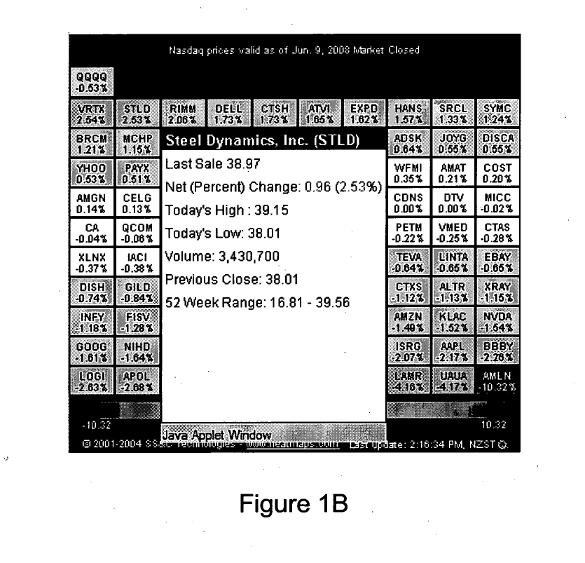

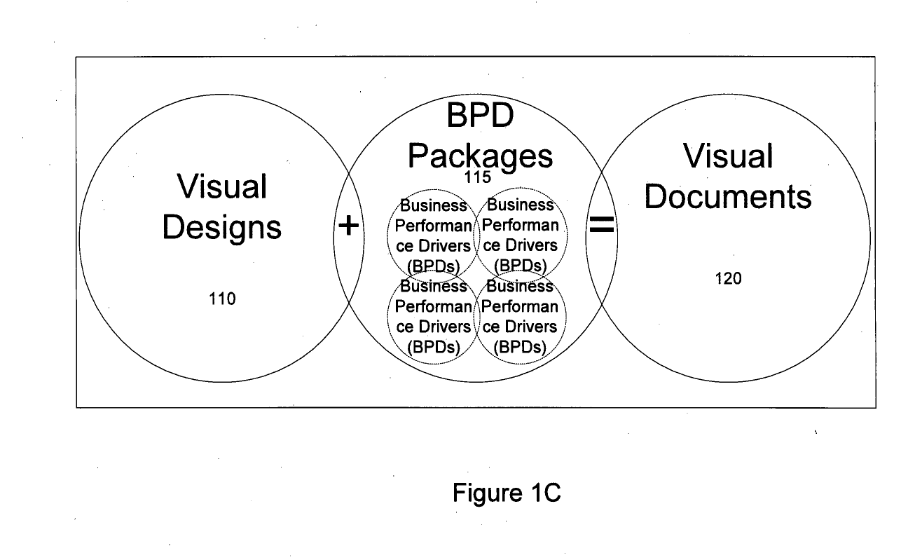

This is shown diagrammatically in FIG. 1A. Some blocks are colored green, which means the stock price is up and some blocks are colored red, which means the stock price is down. The blocks have a varying deepening of the relevant color to indicate the direction that the stock is moving. The deeper the color, the bigger the move.

If a user hovers over a stock, additional intra-day data is presented—as shown in FIG. 1B: Source: Nasdaq.com

The key terms are set out diagrammatically in FIG. 1C. Visual designs 110 are individual visualization techniques. One or more are applied to visualize BPD packages 115 to create visual documents 120.

Many organizations are facing massive and increasing amounts of data to interpret, the need to make more complex decisions faster, and accordingly are turning to data visualization as a tool for transforming their data into a competitive advantage. This is particularly true for high-performance companies, but it also extends to any organization whose intellectual property exists in massive, growing data sets.

One objective of the described solution is to put experts' data visualization techniques in the customer's hands by skillfully guiding the end user through choosing the right parameters, to display the right data, and to create its most useful visualizations to improve business performance.

The described solution is a generic tool and can apply to multiple business areas that require decisions based on and understanding massive amounts of data. The resulting browser-based output is defined as a ‘Visual Document’.

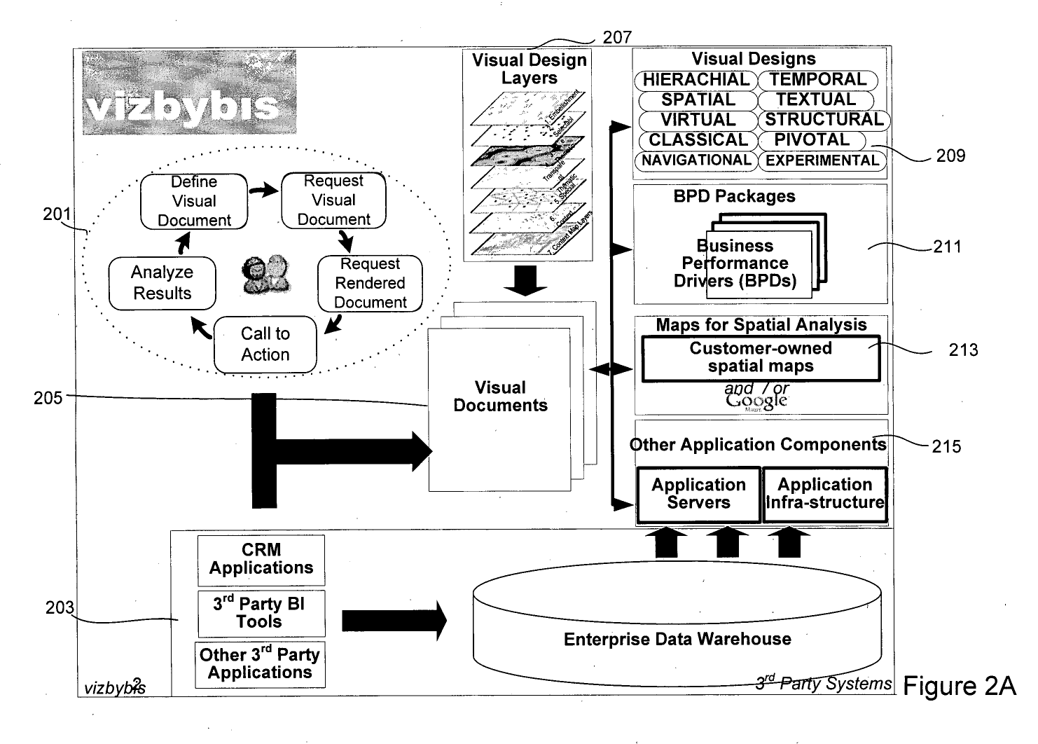

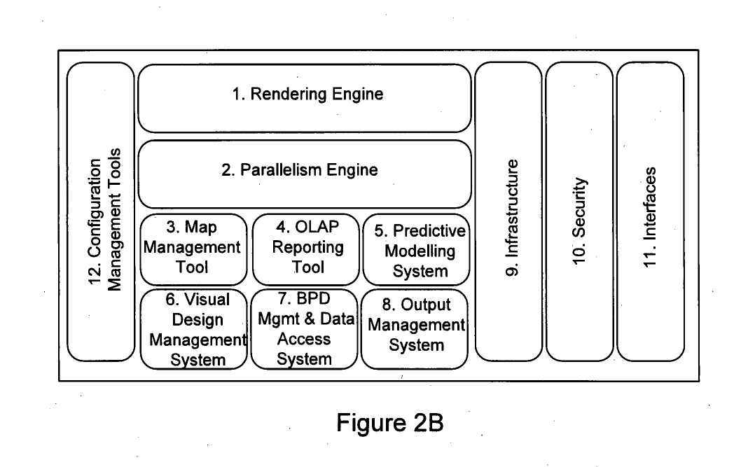

The solution provided is summarized in FIG. 2A.

The system identifies user tasks 201 in the form of defining visual documents, requesting visual documents, requesting rendered documents, calls to action, and analyzing results. These tasks are then detected by the system in conjunction with other systems 203, which include CRM applications, third party Business Intelligence (BI) Tools and other third party applications, all of which may access data stored in an enterprise data warehouse (EDW). The visual design layer concept 207 may be utilized within the visual documents 205. The creation of the visual documents is made in conjunction with a number of different defined visual design types 209, BPD packages 211, spatial analysis maps 213 and other application components 215, such as application servers and application infrastructure.

A Visual Document contains visual representations of data. Access to the data used to construct the visual representation is in many ways analogous to a textual document. It is constructed by applying Business Performance Driver(s) (BPD) data to a specific Visual Design (Visual Designs are grouped into ten classifications).

A Visual Document is designed to illustrate at least one specific point (using the visualization), support the points made with empirical evidence, and may be extended to provide recommendations based on the points made. The Visual Document is the actual deliverable from the software to the software user. Visual Documents may be stored, distributed or analyzed later, as needed.

The Visual Document is fed by data and a metadata database that stores definitions of BPDs—the BPDs are the focus of the Visual Document. A Business Performance Driver is a business metric used to quantify a business objective. Examples include, gross sales or units sold. For instance, the Visual Document may be used to graphically depict the relationship between several BPDs over time.

In the Visual Document, data is rendered in up to seven layers in one embodiment. However, it will be understood that the number of layers may be varied as needed by the user. Specific Visual Document Layers are described herein. However, it will be understood that further Visual Document Layers may be included over and above the specific types described.

Visual Designs are explicit techniques that facilitate analysis by quickly communicating sets of data (termed BPD Packages) related to BPDs. Once constructed, Visual Documents may be utilized to feed other systems within the enterprise (e.g., Customer Relationship Management (CRM) systems), or directly generate calls to action.

The described solution utilizes the best available technical underpinnings, tools, products and methods to actualize the availability of expert content.

At its foundation, the solution queries data from a high performance enterprise data warehouse characterized by parallel processing. This database can support both homogeneous (identical) and heterogeneous (differing but intersecting) databases. The system is adaptable for use with a plurality of third party database vendors.

A scalable advanced web server framework can be employed to provide the necessary services to run the application and deliver output over the web. A flexible and controllable graphics rendering engine can be used to maximize the quality and speed levels required to support both static and dynamic (which could be, for example, animated GIF, AVI or MPEG) displays. All components can operate with a robust operating system platform and within secure network architecture.

Pre-existing (and readily available) third party components can be employed to manage user security (e.g. operating system security), industry specific applications and OLAP (Online Analytical Processing) or other more traditional reporting. The described solution is designed to facilitate speedy and reliable interfaces to these products.

A predictive modeling interface assists the user in analyzing forecasted outcomes and in ‘what if’ analysis.

Strict security, testing, change and version control, and documentation standards can govern the development methodology.

Many organizations are facing massive and increasing amounts of data to interpret, the need to make more complex decisions faster, and accordingly are turning to data visualization as a tool for transforming their data into a competitive advantage. This is particularly true for high-performance companies, but it also extends to any organization whose intellectual property exists in massive, growing data sets.

This clash of (a) more data, (b) the increased complexity of decisions and (c) the need for faster decisions was recently recognized in an IDC White Paper (Gantz, John et. al.; IDC White Paper; “Taming Information Chaos: A State-of-the-Art Report on the Use of Business Intelligence for Decision Making” November 2007), which described this clash as the “Perfect Storm” and that this ‘storm’ will drive companies to make a quantum leap in their use of and sophistication in analytics.

Today's business tools and the way they operate barely allow business users to cope with historical internal data, let alone internal real time, predictive, and external data.

Hence, a new paradigm in business intelligence solutions is required.

### System Overview

As explained above, FIG. 2A shows a high-level overview of the system. There are five key components to the system. These are:

### 1. Visual Documents;

### 2. Visual Designs;

### 3. Business Performance Drivers (and BPD Packages);

### 4. Spatial Maps;

### 5. Application Components.

A description of each of these components is set out below under the respective headings.

### Visual Documents

The Visual Documents form the core of the solution from a user perspective. This may include visualization(s), associated data and/or metadata (typically the visual form) that the user defines requests and interacts with. The Visual Documents may consist of single frames or animated frames (which could be, for example, implemented in AVI, GIF or MPEG format or a sequence of still images).

The Visual Document is typically viewed in a dynamic web browser view. In this interactive view the user may observe, select and navigate around the document.

Once created, the Visual Documents may be stored in the database and may be distributed to key persons (printed, emailed etc.) or stored for later use and analysis.

### Visual Designs

The Visual Designs are a classification of the different types of visualizations that a user may choose. Within each Visual Design category, there are a number of visualizations. For example, the ‘spatial’ category can have retail store location maps, network maps or geographical location maps, such as, for example, maps available from Google™ or Yahoo™.

The described system allows users to select one or more visualizations (e.g. one visual form within a Visual Design category) to create a Visual Document.

There are ten Visual Design categories defined below, however it will be understood that further Visual Designs are envisaged, as well as the number of visualizations within each classification and the number of classifications.

Visual Designs are a classification of the different types of visualizations that a user may choose. Within each Visual Design, there are a number of visualizations.

For example, the ‘spatial’ category can have retail store location maps or geographical location maps.

The visual design types include:
Hierarchical
Temporal
Spatial
Textual
Virtual
Structural
Classical
Pivotal
Navigational
Interactive

### 1. Hierarchical Visual Designs

One purpose of a hierarchical visual design is to present large scale hierarchical data in one display. It is a picture for understanding, monitoring, exploring and analyzing hierarchical data.

Key elements of hierarchical visual designs are:
Data is hierarchical.
Structure of data can determine hierarchy.
They can be overlaid with connections.

This type of visualization may be automatically generated from a table of contents. This automatically generated hierarchy then becomes a special layer over which specific information can be overlaid.

The Hierarchical Visual Design is a hierarchical diagram such as an organizational chart or a correlation matrix.

This Visual Design has at least one natural centre and typically has a higher density toward the fringes of the visualization. The Hierarchical Visual Design can typically be considered as a ‘tree’ structure. The nodes and vertices within the tree structure are best if they are generated automatically from a dataset. This tree structure is a good example of a Special Layer.

The development process will include building a tree that is optimized for this type of Visual Design including heat mapping techniques.

Large scale hierarchical data is represented using various techniques such as mapping to icons, shapes, colors and heights.

Typical uses include mapping of web pages, organizational charts, decision trees and menu options.

### 2. Temporal Visual Designs

One purpose of a temporal visual design is to present temporal based data, such as, for example, revenue per day, in a specially designed calendar or time series view. This calendar view will enable users to view thematic layers that display BPD information such as revenue or sales.

This type of visual design is a completely data defined Visual Design. The key input values are typically ‘start’ and ‘end’ dates along with the ‘number’ of variables to be displayed.

The simplest, and potentially the most useful, Visual Design Special Layer may be a carefully drawn calendar. The calendar may then become a useful Visual Design for date-based Visual Documents.

Temporal analysis is one of the fundamental methods of almost all analysis. Using temporal high density visualizations, users will be able to overlay high density Thematic Layers on well designed Special Layers such as the spiral data visualization shown in the above examples. This analysis can be applied in everything from customer frequency and spend analysis to analysis of the impacts of time of day on the management of a mobile phone network.

It is considered that temporal design patterns are particularly important in terms of analytics as the majority of analytics are time based. Described herein are several examples of producing temporal visual designs.
Non Contiguous Time—For example, weekends can be represented in some interesting ways. The simplest way being not to show them.
Non-linear Time—This allows multiple years of history to be shown where the oldest data is spatially compressed in the Visual Design.
Temporal Special Layers—These can be used to compare quite disjointed types of data. For example, the relationship between external public events, operational payroll sizes and sales revenue. There exists no easy way to numerically join this data together, visually this data can be joined. The technique combines well with simple correlations as it is possible to combine these distinct datasets to show correlations.
Control—One important consideration in visualizing temporal data is the gaining of scientific control. For example, seasonal variables. This is particularly interesting as one year is always different from the next. Quite simply, the start date of each year is never the same as the next, and moving external events such as Easter and ‘acts of God’ such as weather make precise comparison very difficult.

### 3. Spatial Visual Designs

One purpose of a spatial visual design is to present an overview of large scale numerical data in one spatial display (i.e. a space) for understanding, monitoring and analyzing the data in relation to a space.

This type of visual design combines together base maps provided by third parties with rendered thematic layers. These “mash-ups” are user definable and accessible to users.

For example, third party base maps may include customer-owned spatial maps or readily available base maps such as those provided by Google™ Maps or Yahoo™ Maps. The system provides powerful thematic layers over one of these spatial base maps.

One example of a spatial visual design is available at www.weather.comⁱⁱⁱ. This map shows two layers—(1) an underlying heat map overlaid with (2) actual temperature at specific cities. The points are useful as the state boundaries allow the user to determine with relative ease which city is being referenced. The underlying heat map is useful as it allows the user to see the overall trend at a glance.

A second example is available at Information Aesthetics^{iv}. This example shows the travel time from the centre of London outwards using various methods of travel. The use of heat maps here shows very clearly the relationship between distance from the centre of London and travel time.

In a further example, the ‘spatial’ category of visual design can have retail store location maps, network maps or geographical location maps, such as, for example, maps available from^{Google™ or Yahoo™}

Numerical data may be independently mapped using parameters such as hue, saturation, brightness, opacity and size distributed across a defined geographical space.

Geographic mapping has a wide range of uses. In fact with the wide availability of high quality base maps, the world is becoming spatially enabled. Mapping applications can be used for a huge variety of tasks, from customer relationship management to drive time analysis, site selection to insurance risk analysis and telecommunications network analysis.

### 4. Textual Visual Designs

One purpose of textual visual designs is to enable business users to interact and query seamlessly from the structured to the unstructured world.

While it is possible to do basic numeric analysis on variables such as hit frequency and number of clicks per hour, the key method is to use a special layer to construct a sensible schematic of the unstructured data then overlay BPDs. Simply put, the described solution will leverage information visualization to bring structure to the unstructured world.

For example, a heat map may be used as part of a textual visual design.

Unstructured textual information is a huge area of growth in data storage and intuitively, the business intelligence industry expects this data to become a valuable asset. The described solution provides information visualization capabilities that overlay and draw out the non-numeric, but actionable, observations relating to unstructured data, in order to link the numeric data warehouse to the unstructured world.

There are a multitude of Special Layers that may be used with textual data. These textual Special Layers extend from building self organizing maps of textual information to diagrams showing the syntax hierarchy of the words used in a document.

A self organizing map (SOM) consists of components called nodes or neurons. Associated with each node is a weight vector of the same dimension as the input data vectors and a position in the map space. The usual arrangement of nodes is a regular spacing in a hexagonal or rectangular grid. The self-organizing map describes a mapping from a higher dimensional input space to a lower dimensional map space. The procedure for placing a vector from data space onto the map is to find the node with the closest weight vector to the vector taken from data space and to assign the map coordinates of this node to our vector—Source: WikipediaError! Bookmark not defined.

### 5. Virtual Visual Designs

One example of a virtual visual design is a 3D representation of a virtual environment. 3D worlds generate far more accurate and complete data than the real world. As these 3D worlds grow in popularity and become more immersive, the potential for business intelligence tools to be applied to this environment grows significantly.

One example application of the use of a virtual visual design is a retail space analysis tool where transaction data is under-laid as the color of the carpet or shelves. In the case of the shelves, the shelves can also show representations of the products on the shelves.

### 6. Structural Visual Designs

One purpose of a structural visualization is to illustrate the structure of the data. For example, network topology or interconnection between data elements. The interconnections in the examples below show how a simple Special Layer construct can be used to illustrate quite complex connections.

One example of a structural type visual representation is that of the London underground map. The London underground map is a key historic map showing the schematic topology of the London underground. Using this map travelers can intuitively plan out complex routes and interconnects. Without this visualization, navigating the London underground system would be significantly more difficult and complex to understand.

These structural visualizations are very powerful and are closely related to spatial visualizations. Most of the thematic treatments that can be applied to a spatial visualization are equally applicable to a structural visualization.

Examples of uses for such a visual design type would be for visualizing call routing across a network, electricity grid management and route optimization.

It will be understood that a wide variety of Special Layers may be created in this space. These Special Layers essentially generate the structural schematic from the base data.

Typically the interconnections between nodes are used to generate the structure. One important aspect of the structural Special Layer is building the structure in such a way that interconnect line crossing is minimized.

### 7. Classical Visual Designs

Traditional charts provide a simple, common and well-established way of presenting data using classical visual designs. However, traditional charts are user-skill dependent and the herein described system may be used to apply guided Visual Design techniques to traditional charts to significantly extend their usefulness.

One example would be to show a line chart of Speed Vs Time in a simple two dimensional line graph. This type of basic graph shows the data clearly and allows the user to observe any geometric trends.

Some common charts that fall into this design category are as follows:
Scatterplots—Are Cartesian coordinates to show the relation of two or more quantitative variables.
Histograms—Typically show the quantity of points that fall within various numeric ranges (or bins).
Bar graphs—Use bars to show frequencies or values for different categories.
Pie charts—Show percentage values as a slice of a pie.
Line charts—Are a two-dimensional scatterplot of ordered observations where the observations are connected following their order.

### 8. Pivotal or Quartal Visual Designs

Different visualization methods have been suggested for high-dimensional data. Most of these methods use latent variables (such as principal components) to reduce the dimensionality of the data to 2 or 3 before plotting the data. One problem with this approach is that the latent variables sometimes are hard to understand in terms of the original variables.

The parallel coordinate (PC) scheme due to Inselberg and others attempts to plot multivariate data in a completely different manner. Since plotting more than 3 orthogonal axis is impossible, parallel coordinate schemes plot all the axes parallel to each other in a plane. Squashing the space in this manner does not destroy too much of the geometric structure. The geometric structure is however projected in such a fashion that most geometric intuition has to be relearned, this is a significant drawback, particularly for visualization of business data.

Pivotal or Quartal visual designs allow the user to display higher dimensional data in a lower dimensional plot by ranking and splitting variables across various axes. This method may for example be used to display 3D data in a 2D plot.

### 9. Navigational Visual Design

Navigational visualizations use a highly visual interface to navigate through data while maintaining the general context of the data. This data visualization method may use other visual design types so it is differentiated more by the style of how it is used than the implementation standard.

Photosynth for example is a powerful navigational tool for moving between images, its display is designed for navigation of large numbers of linked images. One illustrative navigational representation example is shown by Ubrowser. This navigational visualization example shows web pages represented in a geometry design. The web pages can be navigated through by spinning the cube shown in the example.

Navigational visualizations are designed for users to interactively move through the data. The objective of the visualization is to present a large volume of data in such a way as to enable users to move through the information and gain an understanding of how the data links together.

A number of display techniques are known for displaying information with regard to a reference image (the combination referred to as primary information). Where the limit of primary information is reached a user may wish to know more but be unable to further explore relevant information. A user may also simply wish to explore other aspects although there is more primary information to explore.

A key element of navigational visual designs is that they are interactive and are designed to assist in data navigation and data way-finding rather than for analytical purposes.

### 10. Interactive Visual Designs

This classification is for significantly advanced or interactive visual designs which do not fit within the preceding classifications.

These visualizations vary in nature from pure abstract forms to more tangible forms of visualizations. The key difference is that these visualizations may not be classified within the preceding Visual Design classifications due to their advanced nature or interactivity.

Any Visual Design layer considerations will be dependent on the interaction being considered.

There is opportunity to use common associations to provide iconic views of key events; the common associations are created using the interactive tools and asking users for feedback on the relevant icons. This feedback is then developed into a learned interactive system to provide iconic data representations.

Eye movement sensors can be used to control the interactivity and to learn information about relevant icon usage and control interactivity.

A wide range of user interfaces are used in conjunction with computer systems. Generally these are simply used to provide command or data inputs rather than to analyze the underlying behavior of a user in the context of the operation of a software application.

It would be desirable to operate software applications running on a computer on the basis of observed user behavior in the context of a software application.

### Business Performance Drivers (and BPD Packages)

Business Performance Drivers (BPDs) are a metric applied to data to indicate a meaningful measurement within a business area, process or result. BPDs may be absolute or relative in their form of measurement.

The Business Performance Driver (BPD) concept differs from the known KPI concept by introducing BPDs that

(1) may have multiple dimensions,
(2) place the BPD in the context of the factors used to calculate them,
(3) provide well understood points of reference or metadata around which visual document creation decisions can be made, and
(4) may contain one or more methods of normalization of data.

Common groups of BPDs are called BPD Packages. For example, BPDs relating to one industry (say, telecommunications) can be grouped into one BPD Package. BPDs may be classified into one or more BPD Packages. For example, Net Revenue with normalizations available of per customer or per month may be applicable in a number of industries and hence, applicable to a number of BPD Packages.

### Spatial Maps

Spatial maps allow for a user-owned and defined spatial map and/or for the user to use publicly available context maps such as Google™ Maps or Yahoo™ Maps. In either case, the user can display selected BPDs on the chosen spatial map.

Typically, a user-owned spatial map may be the inside floor space of a business and a publicly available context map may be used for displaying BPDs on a geographic region e.g. a city, county, state, country or the world.

### Application Components

The described application includes two main components, the Application Servers and the Application Infrastructure.

The Application Server includes a number of servers (or server processes) that include the Rendering Engine (to make (or render) the Visual Documents), Metadata Servers (for the BPD Packages, the Visual Designs and the BPDs) and the Request Queue.

The Application Infrastructure is also comprised of a number of servers (or server processes) that may include a Listener (which ‘listens’ for document requests) and central error logging.

Based on the user selections made above (Visual Documents, Visual Designs and BPDs), the user can click on an action and send a communication to a third party system (CRM, Business Intelligence or other application). The third party system could, for example, load the list from the solution and then send out a personalized email to all members on that list.

According to one embodiment, the described server components of the application are a Java based application and utilize application framework such as the IBM™ WebSphere application server framework, other platforms and server applications may be utilized as alternatives. The client application may be a mashup that utilizes the server components or it could be a rich internet application written using the Adobe™ Flash framework.

Other key elements of the system may include:
Parallelism—Parallel processing to increase responsiveness or to increase workload scalability of queries or Visual Documents. This parallelism may also decrease response time for larger visual documents in particular animated images may be executed in a parallel fashion.
Security—System and user-access security. This security may be a combination of authorization and authentication. The security framework may be implemented using the application framework.
Map Updates—A map management tool to update user-owned spatial maps.
Predictive Modeling—This may be an interface to third-party predictive models.
Configuration Tools—The application may be supported by configuration tools to enable rapid deployment of the application.

### Modular Overview

### Module Descriptions

The diagram shown in FIG. 2B shows an overview of the software modules in the described system.

These modules are described in the subsequent table. More detailed descriptions and diagrams of each of the software modules are provided below.

The table below outlines the following four items in relation to each module:
1. Technology System Component: This is the name given to the system component; this name matches the name in the above diagram.
2. High Level Functional Description: Describes the role of the software module.
3. Caching: Indicates whether this module uses caching to optimize performance.

| Technology | | | |
|---|---|---|---|
| System | | | |
| Component | | High Level Functional Description | Caching |
| 1. | Rendering | Produces images and animations; could | Yes |
| | Engine | use Google ™ Maps or Yahoo ™ | |
| | | Maps for spatial context map. | |
| | | The development of Special Layers | |
| | | enables Visual Document produced | |
| | | to have unique capabilities that were not | |
| | | previously readily available. | |
| 2. | Parallelism | Enables parallel execution of requests for | Yes |
| | Engine | high volume of Visual Document output | |
| | | and rapid results delivery to users. | |
| | | The preferred application framework | |
| | | selected is the IBM ™ WebSphere | |
| | | product. | |
| | | This framework enables the application to | |
| | | be scaled across multiple servers. | |
| 3. | Map | Provides key map editing features | Yes |
| | Management | (specifically CAD like) and map version | |
| | Tool | control (desktop and enterprise) tools. | |
| 4. | OLAP | Industry standard online analytical | Yes |
| | Reporting | reporting. For example, sorting, filtering, | |
| | | charting and multi-dimensional analysis. | |
| | | It is desirable that the user interaction with | |
| | | the data selection process in the data | |
| | | view is seamless with the data | |
| | | visualization view. For example, if the | |
| | | user selects 5 customers from the | |
| | | data view, the same 5 customers | |
| | | should be selected in the visualization | |
| | | view. This means that the solution | |
| | | may be a hybrid view (as discussed | |
| | | later). This hybrid view is a ‘simple’ | |
| | | view and is an interface to an industry | |
| | | leading OLAP tool. One option includes | |
| | | interfacing to the OLAP tool via a | |
| | | JDBC interface from the described | |
| | | solution or a web service model for | |
| | | the selection management. | |
| 5. | Predictive | An interface to external predictive | Yes |
| | Modeling | modeling engines; may also have | |
| | System | some modeling systems. For example, | |
| | | Self Organizing Maps (SOM). | |
| 6. | Visual Design | Tools for users to manage the | No |
| | Management | different Visual Designs. | |
| | System | | |
| 7. | BPD | Tools for users to manage the different | No |
| | Management | BPD Packages and their | |
| | and Data | associated BPDs. | |
| | Access | Contains Data Access capability that | |
| | System | enables data to be queried from | |
| | | RDBMS (or potentially other data | |
| | | sources). | |
| 8. | Output | For management of the documents (Visual | Yes |
| | Management | Documents) within the system. | |
| | System | | |
| 9. | Infrastructure | Core system management functions | Yes |
| | | including system logging and Request | |
| | | Queue management. The Request Queue | |
| | | is also described under parallelism and | |
| | | there may be crossover between | |
| | | these two module descriptions. | |
| 10. | Security | Enables access to the system (or parts | No |
| | | thereof) to be properly controlled and | |
| | | administered. | |
| 11. | Interfaces | Allows services to be called by (or to call) | No |
| | | external applications. | |
| 12. | Implementation | Tools to deploy and configure the software | Yes |
| | Tools | system. | |

### Architectural Views of the System

This section contains descriptions and diagrams of the architectural views of the system. The architecture shows how the system components fit and operate together to create an operational system. If compared to a vehicle, the wiring diagrams, the physical body, the driving circle and key complex components like the engine would be shown in architectural views.

This view does not describe how the system is written; it describes the high-level architectural considerations.

Architectural considerations are typically implemented by one or more software modules. The modular view described herein lays out a high-level view of how the software modules are arranged.

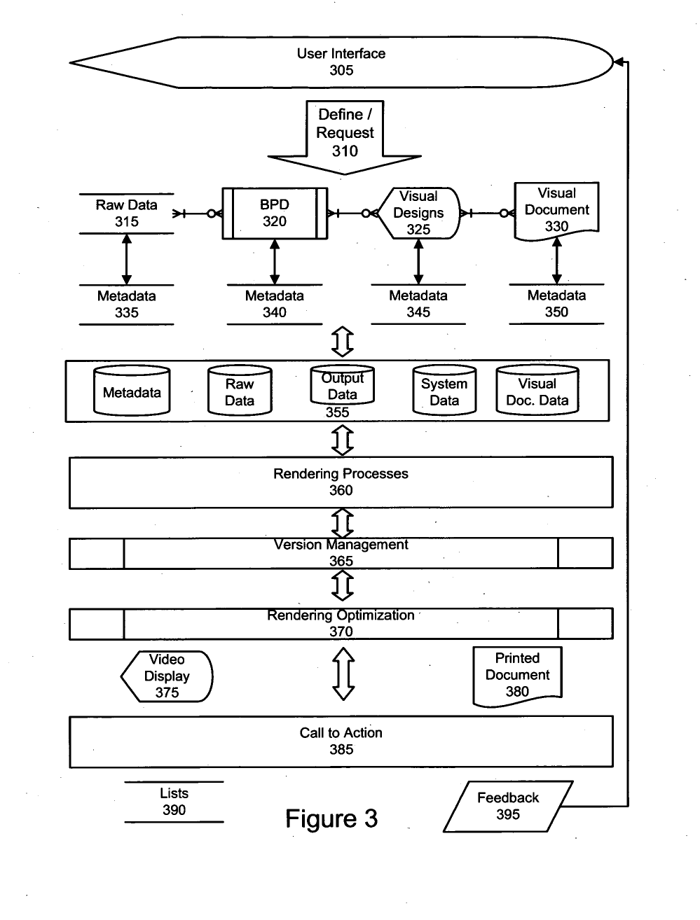

FIG. 3 shows a general overview of the data flow within the system.

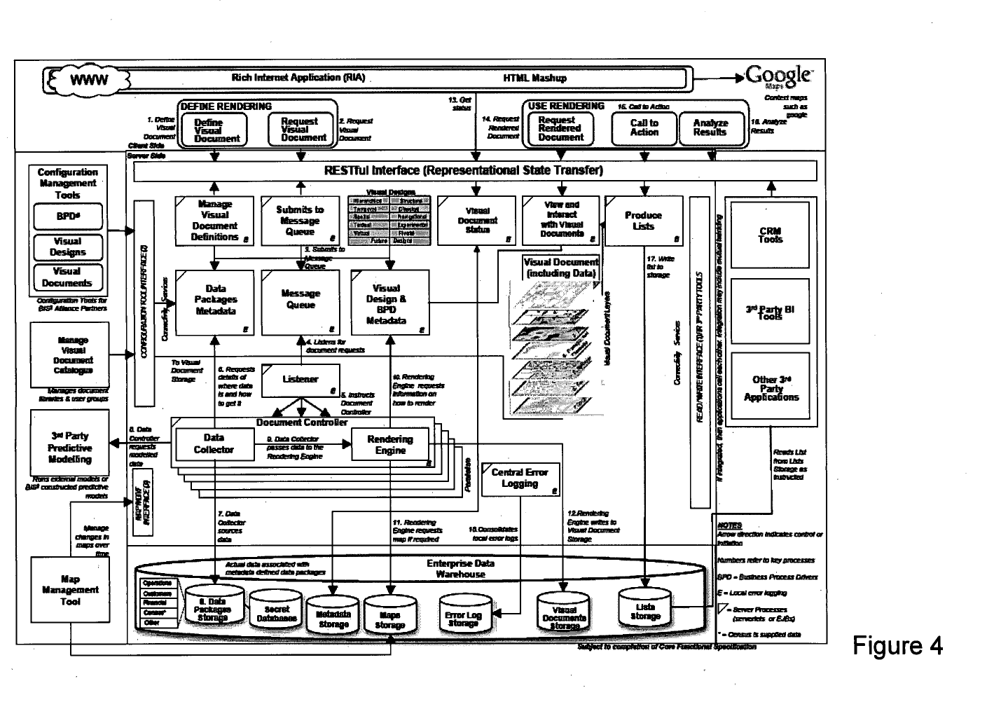

FIG. 4 shows the architectural overview of the described solution. This diagram is elaborated by the diagrams and descriptions in following sections of this document.

The following modules or components are shown:

Web interface Module 4105: User interfaces are browser based or may be a web services client, a rich internet application or may be a thick client. In all cases the user interface uses the same interface to the back end services.

Rendering Definition Module 4110: The user interface is used to define and request the rendering of Visual Documents

Rendering Use Module 4115: Visual Documents are used for analysis, and precipitate calls to action.

Connectivity Services Module 4120: The definition and rendering of Visual Documents is performed through a set of programs or services called the Connectivity Services.

Configuration Management Tools Module 4125: Multiple versions of the basic elements; BPD, Visual Design, Visual Documents; are managed by a set of programs called the Configuration Management Tools.

Visual Document Management Catalog 4130: One such Configuration Management Tool (4125) is a set of programs that manage a users' catalog of available Visual Documents.

Predictive Modeling Module 4135: Predictive modeling is used for forecasting unknown data elements. These forecasts are used to predict future events and provide estimates for missing data.

Map Management Tool 4140: Another of the Configuration Management Tools (21125) is the Map Management Tool. It is designed to manage versions of the spatial elements of a visual design such as a geographic map or floor plan.

Visual Document Definitions Management Module 4145: Visual Document Definitions are managed through the use of metadata (4175).

Message Queue Submission Module 4150: Requests for Visual Documents are handled through queued messages sent between and within processes.

Visual Design Type Module 4155: Visual Documents are comprised of one or many Visual Designs in these categories.

Visual Document Status Module 4160: The status of Visual Documents is discerned from the metadata and displayed on the user interface.

Interaction and Visual Document View Module 4165: The user interacts with the Visual Documents through the user interface, and appropriate changes to and requests to read are made to the metadata.

List Production Module 4170: Where additional output such as customer lists are required, they are requested using the user interface and stored in the EDW (4215).

Data Packages Metadata Module 4175: Metadata is used to describe and process raw data (data packages).

Message Queue Module 4180: Messages may be queued while awaiting processing (4150).

Visual Design and BPD Metadata Module 4185: Metadata is used to describe and process the BPD's and Visual Designs associated with a particular Visual Document.

Visual Documents, Module 4190: Visual Documents may be comprised of layered Visual Designs.

Third Party Modules 4195: Visual Documents may be used with or interact with other third party tools.

Listener Module 4200: The listener processes messages (4150) in the message queue (4180)

Document Controller Module 4205: The document controller is used to provide processed data to the rendering or query engines.

Central Error Logging Module 4210: System errors are detected and logged in the EWP (4215).

EDW 4215: All data is typically stored on a database, typically, multiple fault tolerant processors in an Enterprise Data Warehouse.

The following architectural components are described in more detail.

| Architectural | |
|---|---|
| Component | Description |
| Connectivity | This is a common communication service that is used |
| Services | when sending messages between systems (i.e. the |
| | described solution and 3^{rd} party tools) and between the |
| | described application layer and the user interface layer. |
| Configuration | Allows specialized users to configure Visual Designs and |
| Management | Visual Documents to their needs - which differ from the |
| Tools | default configuration provided. |
| Manage Visual | Gives selected users the ability to search, sort, group, and |
| Document | delete Visual Documents in the Visual Document |
| Catalog | Catalog. |
| Predictive | External modeling systems that use data sent from the |
| Modeling | described solution to perform complex calculations to |
| | produce predictive data. This predicted data is piped |
| | through the described solution to the user. |
| Map | This is an application that enables users to create modify |
| Management | and delete individual maps to manage the complete |
| Tool | sequences, this is very appropriate for management of |
| | floor plans. |
| Data Packages | The services responsible for providing metadata that |
| Metadata | enables the requester (typically, Data Collector) to source |
| | the data for the BPD. |
| Visual | The services responsible for providing the metadata to |
| Design & | the requester (typically the Rendering Engine) that |
| BPD Metadata | enables the construction of the Visual |
| | Documents. |
| Request Queue | The Request Queue manages the communication of |
| | requests for rendering of Visual Documents. These |
| | communications may be scheduled. |
| Document | The Document Controller consists of two components. |
| Controller | The first is the Data Collector responsible for reading the |
| | appropriate metadata and retrieving the data from the |
| | EDW (Enterprise Data Warehouse). This data is passed |
| | to the Rendering Engine that is responsible for producing |
| | the Visual Document. Document Controllers run parallel |
| | Visual Document requests, build and store documents. |
| Read/Write | The described solution provides a common interface for |
| Interface for 3^{rd} | 3^{rd} party tools to communicate with e.g. CRM |
| Party Tools | applications. |
| 3^{rd} Party BI | One of the 3^{rd} party tools that the described solution may |
| Tools | integrate with is an external OLAP tool. |
| Secret | Secret databases are a method of sharing encrypted |
| Databases | databases and providing a SQL interface that enables end |
| | users to run queries against atomic data without |
| | discovering the details of the data. |

The following terms have been also been used in FIG. 4. These are explained in more detail below.

| Architectural | |
|---|---|
| Component | Description |
| Logging | Logging (for example, error logging and access |
| | logging) is an inherently difficult activity in a |
| | parallel independent and predominantly stateless |
| | system. |
| | The main issue that arises is that logging presents |
| | potential links between systems and therefore |
| | dependencies. |
| | Typically within the application, each server will be |
| | responsible for its own logging. This ensures that the |
| | system scales without degradation in performance. |
| | A separate process (central log reader) may be used |
| | to consolidate these logs dynamically as and when |
| | required. |
| Web Server | Web Servers respond to requests from users to |
| | provide Visual Documents. They read any required |
| | information from the metadata servers and Visual |
| | Document storage servers. If necessary they write |
| | Visual Document requests to the Request Queue. |
| Metadata | Metadata servers are responsible for storage and |
| Servers/Storage | user views of metadata. The metadata servers are |
| | also responsible for the validation of user rights to |
| | read Visual Documents (within the application). |
| Visual Document | The Visual Document Catalog is a secure storage for |
| Storage | all Visual Documents. Access is only possible when |
| | security requirements are met. |
| Data Collector | Typically the data collector queries the customer's |
| | data warehouse. The data warehouse can be |
| | augmented with additional subscribed |
| | embellishment data. This will provide the raw data |
| | that is represented visually back to the user. |
| BPD Packages | The described solution will use metadata to define |
| Metadata | groups of BPDs. These groups of BPDs are called |
| | BPD Packages. BPD Packages enable both internal |
| | data measures to be efficiently installed and external |
| | datasets to be provided. |
| | BPD packages contain no data. |

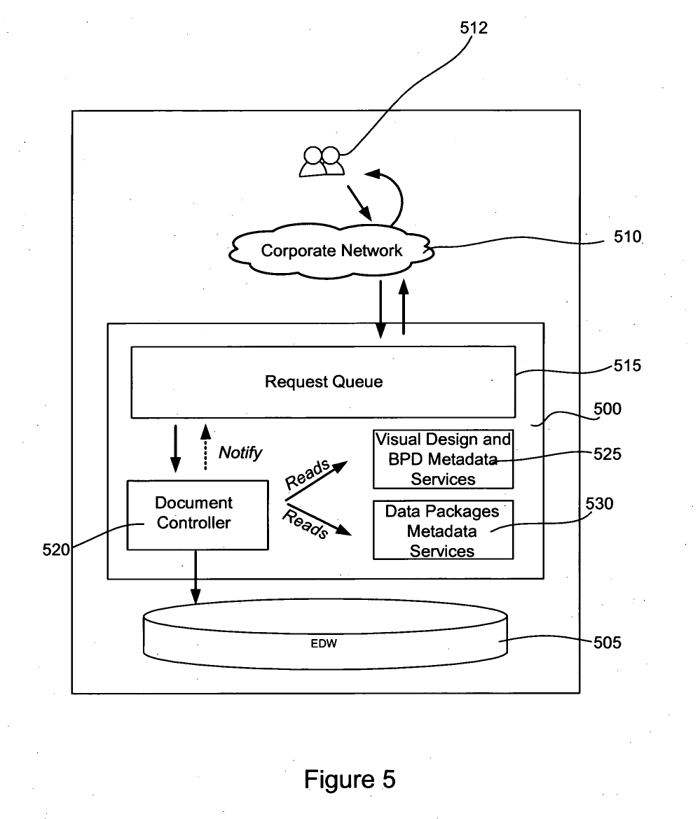

A further high-level system delivery overview of the solution is set out as shown in FIG. 5.

The described solution 500 is hosted by the enterprise 510. The figure shows the logical flow from the submission of a request to the end result, viewing the rendered Visual Document.

The data being visualized belongs to the customer 512 and the submitted request is unknown to the entity running the visualization system 500.

The controlling entity, integrators and customers may wish to have summaries of technical performance data (usage patterns, errors etc) sent from the operational system back to the integrator or controlling entity.

The system 500 has access to the data in a EDW 505. The system utilizes a request queue 515 to control requests from a corporate network 510. These requests are forwarded to a document controller 520. The document controller 520 accesses both the EDW 505 and reads visual designs and BPD metadata services 525, as well as data packages metadata services 530.

The system described thus enables various methods to be performed. For example, data is transformed into visually interpretable information. The visually interpretable information is in the form of visual representations that are placed within one or more visual documents.

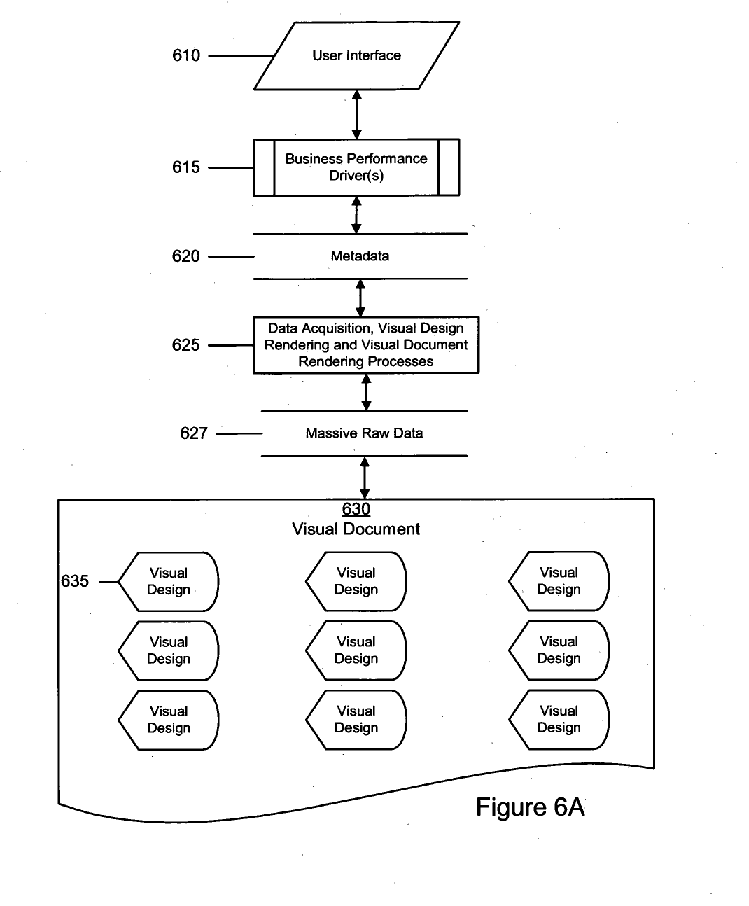

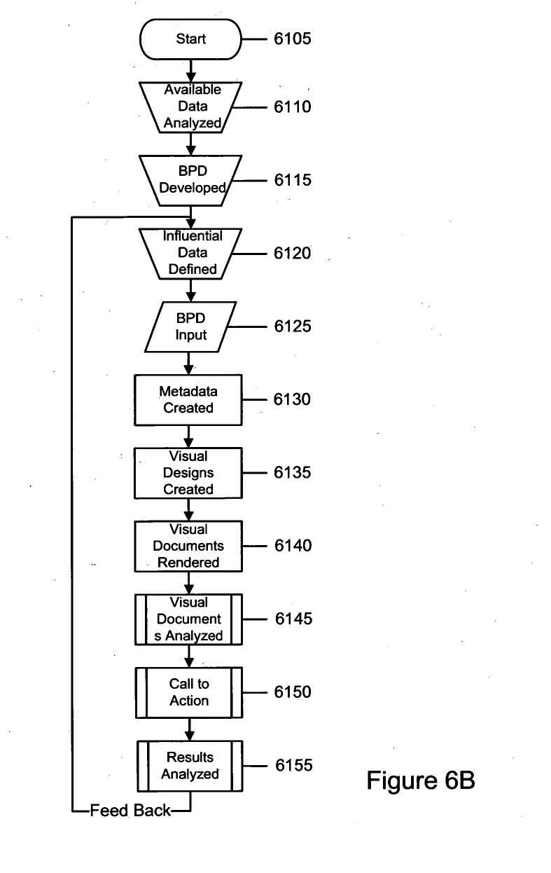

FIG. 6A shows a general data flow diagram for the described system.

The User Interface 610 allows the user to define BPD's 615 in terms of raw data 627, which become the focus of the Visual Document 630.

Further, the User Interface 610 allows the user, through automated expert help, to create the Metadata 620, the most appropriate Visual Designs 635 that make up the Visual Document 625 in order to provide detailed analysis of data related to the BPD 615. The data acquisition, visual design rendering and visual document rendering processes utilize massive amounts of raw data 627.

The Metadata 620 is used by the Processes 625 to optimize the acquisition of the appropriate Data 627, processing of the data into useful information, and to optimize the creation and rendering of the Visual Designs 635 and the Visual Document 630 that contains them.

This method includes the steps of providing comprehensive yet easy to understand instructions to an end user that has accessed the system and the visual design application. The instructions assist the end user in obtaining data associated with a theme, wherein the theme may be focused on objectives that have been derived from the data. The objectives may be business objectives, for example. In this way, the system guides a user carefully through the many choices that are available to them in creating the visual representations, and the system automatically tailors its instructions according to not only what the user requires, but also according to the data that is to be represented. The system focuses on providing instructions to enable a visual representation to be created that will enable an end user to more effectively understand the data that has been collated.

Further, the instructions assist the end user in determining one or more summaries of the obtained data that enable the end user to understand the theme, as well as organizing the determined summaries into one or more contextual representations that contribute to the end user's understanding of the theme.

Further, instructions are provided that assist an end user in constructing one or more graphical representations of the data, where each graphical representation is of a predefined type, as discussed in more detail below, and includes multiple layers of elements that contribute to the end user's understanding of the theme.

Finally, instructions are provided to assist an end user in arranging the produced multiple graphical representations in a manner that enables the end user to understand and focus on the theme being represented as well as to display or print the organized graphical representations. The system assists in the organization or arrangement of the representations, elements thereof, within the visual document so as to ensure certain criteria are met, such as, for example, providing a suitable representation in the space available, using the minimum amount or volume of ink to create the representation, and providing a suitable representation that depicts the theme in a succinct manner, or visually simplistic manner.

The data being processed to create the graphical representations may be particularly relevant to the theme being displayed, disparate information or indeed a combination of relevant and disparate information.

There are multiple types of graphical representations that may be included within the visual document. The types are discussed in more detail below and include a hierarchical type, a spatial type, a virtual type, a classical type, a navigational type, a temporal type, a textual type, a structural type, a pivotal type, and an interactive type.

Further, the instructions may assist an end user in arranging the graphical representations in order to display high density data in a manner that conveys important information about the data, rather than swamping the end user with multiple representations that look impressive but do not convey much information.

In addition instructions may be provided to assist the end user in arranging the graphical representations to allow supplementary information to be added, where the supplementary information may be provided in any suitable form. Particular examples provided below depict the supplementary information being provided in subsequent visual layers that overlay the graphical representation. Alternatively, or in addition, supplementary information may include additional elements to be displayed within a single layer of the representation, for example, in the form of widgets.

FIG. 6B shows a flow diagram according to this embodiment of the invention.

Step 6105: Process Starts. User decides to manage the business.

Step 6110: Available data is identified and analyzed.

Step 6115: Business Process Drivers (metrics defined in terms of the data to indicate a meaningful measurement within a business area, process or result).

Step 6120: Data influencing the BPD metrics are identified.

Step 6125: BPD's are input into a computer system

Step 6130: BPD is categorized and appropriate metadata describing it is generated.

Step 6135: Visual Designs to display the influential data are created.

Step 6140: Visual Designs are aggregated into Visual Documents and rendered. Adjustments are made based on the freshness of all components (e.g., BPD, available data).

Step 6145: Visual documents are analyzed by the end user.

Step 6150: The end user decides on and implements actions based on the analysis in 6145.

As touched on above, business performance drivers (BPDs) are used to enable more efficient data analysis so as to produce accurate and relevant visual representations of the data. A BPD is a form of advanced business measure wherein additional information is included within the BPD that enables the system using the BPD to understand how to manipulate the BPD. That is, one or more intelligent attributes are included with the business measure to form the BPD, where those attributes reference or include information on how the BPD is to be processed or displayed. The form of processing and display may also be varied according to the device type or media upon which the business measures are to be displayed.

The attributes are attached to the business measure by storing the BPD in the form of a mark up language, such as, for example, HTML or XML. It will however be understood that any other suitable format for storing the BPD may be used where the attributes can be linked to the business measure.

In the example of HTML, the attribute is included as a tag. One such example would be to include the data or business measure within the body of the HTML code and follow the business measure with a tag that references the attributes, or dimensions, associated with that business measure.

Further, the attributes may also be modified or deleted, or indeed new attributes added, during or after the processing of the BPD so that the attributes are maintained, or kept up to date, bearing in mind the requirements of the entity using the BPD to visualize their data.

The business performance drivers, or measurable business objectives, are identified in order to create graphical representations of the business objectives, where those representations are placed within a visual document. A business objective may be, for example, a metric associated with a business.

Instructions are provided by the system to the end user, in order to assist the end user in establishing multiple business objectives as functions of available metrics, as well as assisting the user in organizing the business objectives into a contextual form that contributes to the end user's understanding of the business objectives.

Further, instructions are provided to assist the end user in constructing one or more graphical representations of the business objectives, where each graphical representation is of a predefined type, as mentioned above and described in more detail below. Further, each graphical representation includes multiple layers of elements that contribute to the end user's understanding of the business objective.

The elements within the graphical representation may include, for example, a shape, position, color, size, or animation of a particular object.

Instructions are also provided by the system to assist the user in arranging multiple graphical representations in a suitable manner that enables the end user to understand and focus on the business objectives being represented.

Finally, the end user is also assisted with instructions on how to display the organized graphical representations.

The following section describes a method of creating a visual representation of data in the form of a visual design.

The method includes the steps of the system providing instructions to an end user to assist the end user in constructing multiple graphical representations of data, where each graphical representation is one of a predefined type, as defined above and explained in more detail below, and the graphical representation includes multiple layers of elements that contribute to the end user's understanding of the data

The system also provides instructions to an end user that assist the end user with arranging multiple graphical representations of different types within the visual representation in a manner that enables the end user to understand and focus on the data being represented, as well as providing instructions to assist the end user in displaying the visual representation in a suitable manner.

The visual representation may be displayed in a number of different ways, such as on a color video screen or a printed page. The information that is forwarded to the display device to create the visual representation may differ according the type of display device so that the visual representation is produced in the best known suitable manner utilizing the advantages of the display device, and avoiding any disadvantages.

The data being displayed may be based on a measured metric or an underlying factor that affects a metric.

The elements within the graphical representation may include a shape, position, color, size or animation of a particular object.

Although a single visual document may include only one type of graphical representation, either in the form of multiple graphical representations or a single representation, there will also be situations where multiple types of graphical representations may be organized within a single visual document in order to convey different aspects of the data, such as, for example, temporal as well as spatial information. The inclusion of different types of graphical representations within a single document can provide an end user with a better understanding of the data being visualized.

Further, the single visual representation may be arranged to be displayed as an image on a single page or screen. This may be particularly useful where space is at a premium yet the user requires the visual representation to be provided in a succinct manner. For example, the user may request certain information to be displayed in a visual representation on a single mobile telephone display, or a single screen of a computer display, in order to show a customer or colleague the results of a particular analysis without the need to flick between multiple screens which can result in confusion, a waste of energy and ultimately a loss of understanding of the visual representations.

The same issue applies to printed representations, where the result of the system enabling a user to arrange a single representation, which may include multiple elements or layers, on a single page not only succinctly represents the data being analyzed but also saves the amount of paper being printed on and the amount of ink being used to print the document.

Further, the amount of ink required for a visual representation may be further reduced by providing instructions to the end user in a manner that directs them to control and use white space in a representation in an efficient manner so as to reduce the requirement of ink.

Multiple types of graphical representations may be merged together within a single visual document, or representation.

As mentioned above, instructions can be provided by the system to assist the end user in adding supplementary information to the visual representation, and the supplementary information may be provided in layers within the representation.

### Visualization Framework

The following description provides the visualization framework that, will support embodiments of the present invention. The description includes an overview of the importance of Visual Design including a brief historical recount of a world-recognized leading visualization. The description also sets out the Visual Design classifications for the described solution.

It will be understood that the Visual Design examples described in this section are examples for illustrative purposes to identify the concepts behind how the visualization is produced. Therefore, it will further be understood that the concepts described can produce visual designs different to those specifically described. The Visual Design examples shown are also used to help the reader understand the narrative describing the Visual Designs.

The system described is specifically adapted to create actual specific visualization designs relevant to selected vertical and horizontal industry applications being deployed.

A vertical industry application is one that is associated with a solution directed at a specific industry, such as, for example, the entertainment industry. In this example, BPDs relevant to that industry are created, such as rental patterns of movies over different seasons.

A horizontal industry application is one that is associated with solutions across multiple industries. For example, the BPD may be based on CRM analytics, which applies across a whole range of different industries.

Design is now a fundamental part of almost every aspect of how people live work and breath. Everything is designed from a toothbrush to every aspect of a web site. Compare visual design to architectural design—in both cases anybody can draw quite complex pictures. The resulting pictures could have stimulating and well drawn graphic elements. In both cases, the question is why does the world need designers? Exploring this question more deeply one can ask—does it make such a difference to how one perceives and understands a design when it is made by a professional rather than an amateur?

The trend in business intelligence is to design tools to provide flexibility and leave the world of visual design to the amateurs. Stephen Few comments in Information Dashboard Design^{v} that “Without a doubt I owe the greatest debt of gratitude to the many software vendors who have done so much to make this book necessary by failing to address or even contemplate the visual design needs of dashboards. Their kind disregard for visual design has given me focus, ignited my passion, and guaranteed my livelihood for years to come.”

Visual Designs within the described framework are well thought through in how the data is displayed. The described system allows good information visualization design concepts to be captured and delivered back to users as Visual Documents using unique data processing and analysis techniques.

### Visual Designs

### Method or Visual Design Classifications

According to this embodiment, ten Visual Design types are defined and incorporated into the described system. It will be understood that additional Visual Designs may be further defined including the creation of certain examples and actual Visual Designs for specific industry applications.

The visual design types include:
Hierarchical
Temporal
Spatial.
Textual
Virtual
Structural
Classical
Pivotal
Navigational
Interactive

The following describes a method for the assessment of Visual Design quality. In assessing the quality of a Visual Design the following factors should be considered:
Alternative approaches—To assess the capability of a Visual Design it is important to contrast it with other visualization methods. In particular one should compare the visual design to a classical graph or table of numbers. This comparison is important as many data visualizations add considerable graphic weight but little informational value.
Visual simplicity—Looking at a visualization should not overload the mind. The simplicity of the visualization is important as it enhances interpretation and allows common understanding without training. Some visualizations require considerable training to be applied. In general, the described solution will not use these visual designs.
Data density—the density of data in a visualization is a critical measure of its overall value. Higher density visualizations, if successful in maintaining their simplicity, have considerable potential to increase the flow of information to end users.
Volume of ink used—Is the visual design using negative space to show key information? This use of negative space allows lower volumes of ink to be used while showing the same or higher density of information. In addition, ink required is generally reduced as the number of “views” or pages of data is reduced to convey the same volume of data.
Capability to be illuminated with detail—In the end, data visualization becomes information visualization when the specific details are shown. The ability of a visualization to hold detailed information in specific places, often achieved with labels, is a key element in determining its value as an information visualization.

### Visual Design Layers

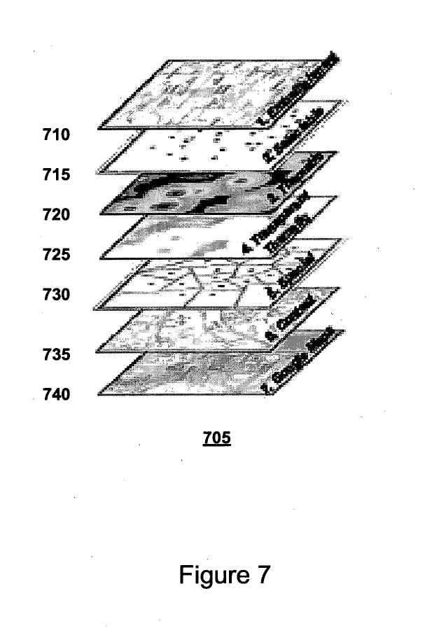

There are seven defined Visual Design Layers which are set out diagrammatically as shown in FIG. 7. Other visual design layers may be added as appropriate.

These seven Visual Design Layers are described in the following table:

| Visual Design | | |
|---|---|---|
| Layer Type | | Description |
| 1. | Embellishment | Embellishment Layers have labels, symbology |
| | Layers | and/or other detailed information that is used to |
| | | illuminate information that is displayed in the lower |
| | | layers. The overlay can also include controls such |
| | | as progress bars or spark-lines. |
| 2. | Selectable | Selectable Layers are interactive and consist of |
| | Layers | items that can have associated data. On a retail |
| | | spatial map it includes store locations as they have |
| | | associated data. Selectable Layers are typically not |
| | | obscured by thematic treatments. |
| 3. | Thematic | Thematic Layers overlay colors or heatmaps on |
| | Layers | Special Layers. These thematic treatments become |
| | | the core visual impact of the final Visual |
| | | Document. |
| 4. | Transparent | Transparent Thematic Layers are very similar to |
| | Thematic | Thematic Layers (in fact are an alternative). The |
| | Layers | only difference is that they are graphically merged |
| | | using a transparent overlay. For example, this kind |
| | | of layer is necessary to overlay heatmaps on |
| | | maps.google.com. |
| 5. | Special Layers | Special Layers construct the structure of the data. |
| | | Specifically the Special Layer understands how to |
| | | automatically draw the data so that other thematic |
| | | treatments can be applied. Special Layers include |
| | | mundane layers such as layers of polygons. |
| 6. | Context Layers | These are the lowest level of the visualization; they |
| | | include background maps and other contextual |
| | | information. |
| 7. | Context Map | This is a type of context layer that is rendered from |
| | Layers | a map such as Google ™ Maps, Yahoo ™ Maps |
| | | etc. This may be a road map, satellite map or |
| | | any other map. It is past as a set of tiled images |
| | | and as such can only be used as a Context Layer. |
| | | Typically, a Transparent Thematic Layer will be |
| | | used to display thematic data on a context map |
| | | layer. |

In terms of the Special Layer, two examples of Special Layers are set out below:

### A. Classic Example of Special Layer: Voronoi Diagram

### Source: Wikipedia^{vi}

In mathematics, a Voronoi diagram, named after Georgy Voronoi, also called a Voronoi tessellation, a Voronoi decomposition, or a Dirichlet tessellation (after Lejeune Dirichlet), is a special kind of decomposition of a metric space determined by distances to a specified discrete set of objects in the space, e.g., by a discrete set of points.

In the simplest and most common case, in the plane, a given set of points S, and the Voronoi diagram for S is the partition of the plane which associates a region V(p) with each point p from S in such a way that all points in V(p) are closer to p than to any other point in S.

A Voronoi diagram can thus be defined as a Special Layer, where a set of polygons are generated from a set of points. The resulting polygon layer can then be subjected to thematic treatments, such as coloring.

### B. Non Traditional Example of a Special Layer: Calendar

A calendar can be generated as a Special Layer for display of a temporal visual document. This Special Layer would require a ‘start date’ and an ‘end date’, most other information regarding the nature and structure of the Calendar could be determined automatically. The thematic layers would then use the structure of the calendar as a basis for thematic treatments such as coloring and contouring.

In an example from ENTROPÍA^{vii} a calendar is shown that can be created into a spiral. The structure and layout of this spiral will be the subject of considerable design discussions by information designers focused on issues such as aesthetics and clarity of information. The result of this discussion is a visual design of a spiral calendar Special Layer. This Special Layer can then be used for thematic treatments such as coloring.

### Visual Design Types

Of the ten defined types of visual design, the temporal visual design will now be described in more detail below.

Embodiments of the present invention are described herein with reference to the above system adapted or arranged to perform a temporal data visualization method.

In summary, the system includes at least a processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the system may include one or more communication devices (wired or wireless) for communicating with external and internal devices, and one or more input/output devices, such as a display, pointing device, keyboard or printing device.

The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language. Further, the program instructions may be stored in any suitable manner such that they can be transferred to the memory device or read by the processor, such as, for example, being stored on a computer readable medium. The computer readable medium may be any suitable medium, such as, for example, solid state memory, magnetic tape, a compact disc (CD-ROM or CD-R/W), memory card, flash memory, optical disc, magnetic disc or any other suitable computer readable medium.

The system is arranged to be in communication with external data storage systems or devices in order to retrieve the relevant data.

### Temporal Visual Designs

One purpose of a temporal visual design is to present temporal based data, such as, for example, revenue per day, in a specially designed calendar or time series view. This calendar view will enable users to view thematic layers that display BPD information such as revenue or sales.

One example of a temporal representation is given by Lee Byron, Megamu^{viii}. The key elements show an approach on how to create a histogram representing music listening history.

A further example of a temporal representation is given at ENTROPÍA^{ix}. This example shows a spiral data visualization showing time periods in 2008 laid out into an increasing spiral.

The display or use of multiple sets of information having a different periodicity has been problematic in the past. For example where calendar years vary it can be difficult to align events known to have a correlation, such as leap years and movable holidays such as Easter.

It would be desirable to graphically display or use data sets having different periodicity so that correlated events are aligned.

As the globalization of communication continues understanding the basic measures of date and time is a key factor in understanding global patterns. The current methods are focused on conversion of one system to a second or third system, however they do not create both a visual representation and a method of interacting with these quite different systems.

When data sets have different periodicity it can be difficult to visually represent the data sets so as to reveal the correlation between events. For example a comparison of sales over two years may lead to erroneous conclusions being drawn if the holidays for each year are not correlated.

In a first case common events may be identified. This may be public holidays or other relevant time based events. The data relating to the common events may be aligned and the intervening data reformatted (this may include omitting, compacting or stretching intervening data). This alignment of data based on events may vary depending upon the granularity at which the data is viewed so that with increasing granularity the data sets are more aligned. Alternatively the data sets may be aligned according to events at all levels of granularity.

The events against which data sets are correlated need not be natural time related events. For example, they could be business events, cultural events, a level of completion etc. For example, the events could relate to stages of a project (the x axis) and the y axis could show the time to complete a stage or some other measure.

According to another aspect the common periodicity between data sets may be determined and all data sets correlated to the common periodicity. For example one set of data may be based on a 5 day week and another set based on a 7 day week. These may both be formatted to a weekly format with the 5 day data stretched to match a 7 day week or nulls used for the weekend.

In another instance absolute time may be common aspect of different calendars, for example Gregorian and Chinese calendars have different periods of absolute time. This invention creates a common representation and mathematical model that enables both the viewing and the querying of data across these two (and potentially other) calendars.

In a further embodiment of this invention the different measures of time and date are used to construct queries in a dataset. For example seasonal measures of time may be used to create queries against a database.

In a further embodiment this invention can be used to show the absolute and relative time of various events, enabling display the personal date or time, the local date or time and the absolute date or time on one easily understandable representation. Furthermore this would enable the user to query information using either personal, local or absolute date or time.

The data visualization techniques described herein transform the raw data received into different temporal arrangements to enable further or hidden information within the raw data to be visually represented in a manner that conveys the information to a user in an efficient manner.

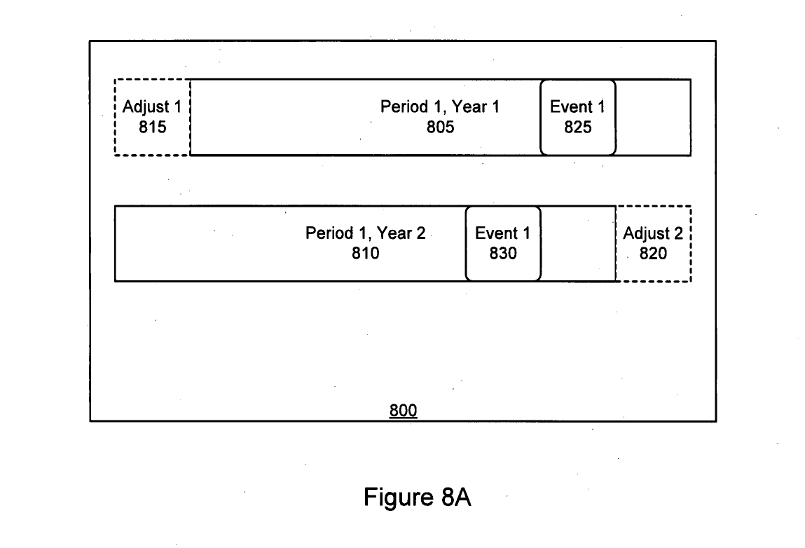

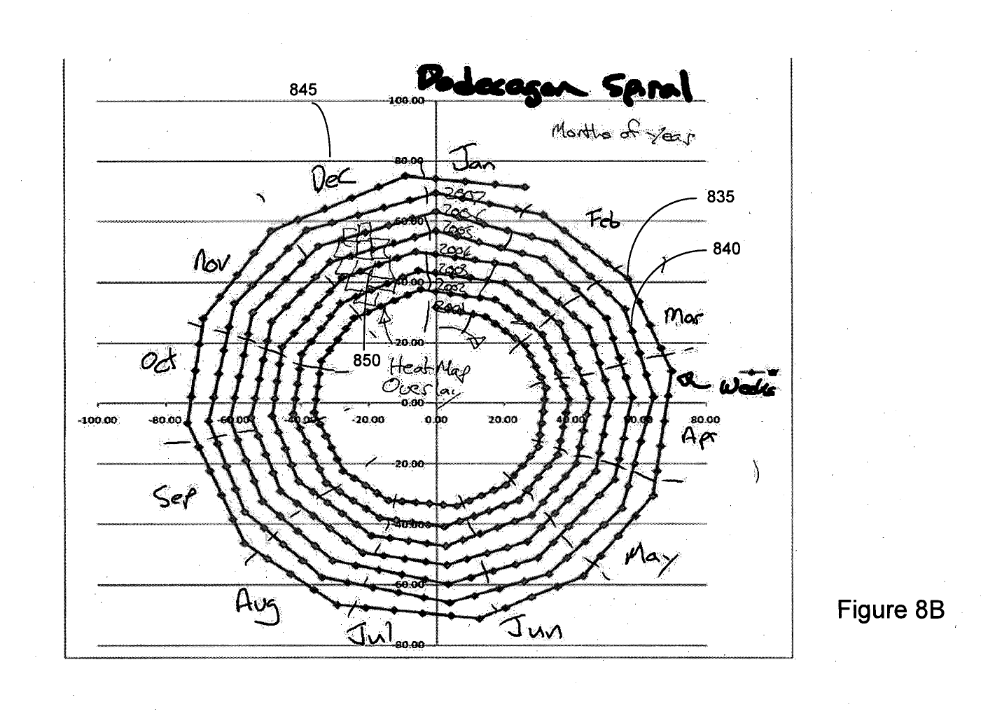

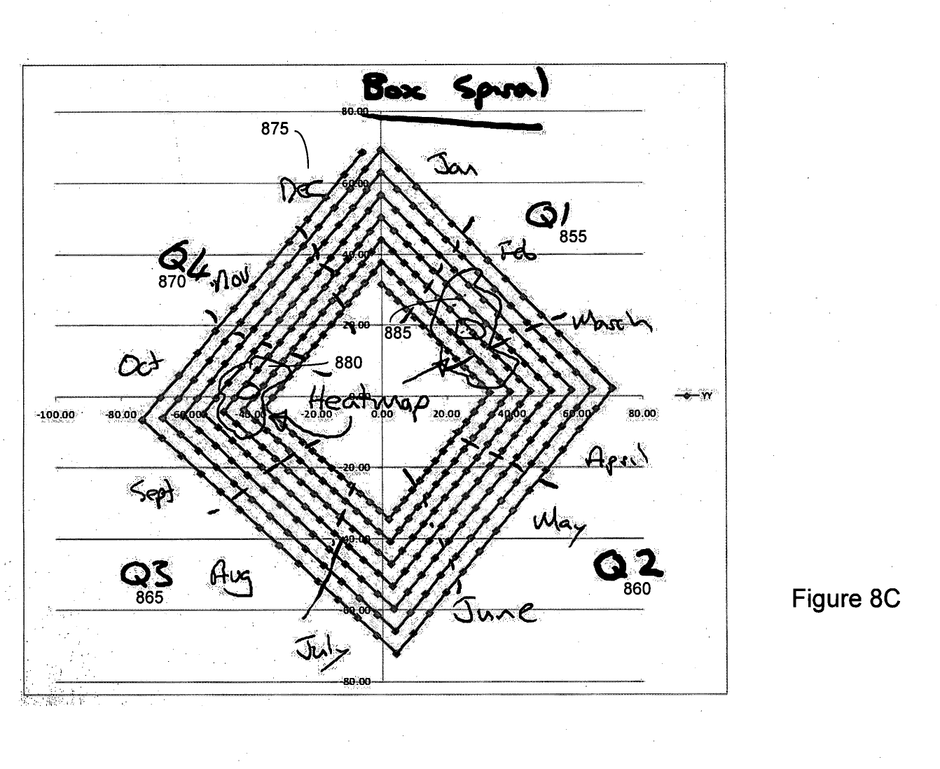

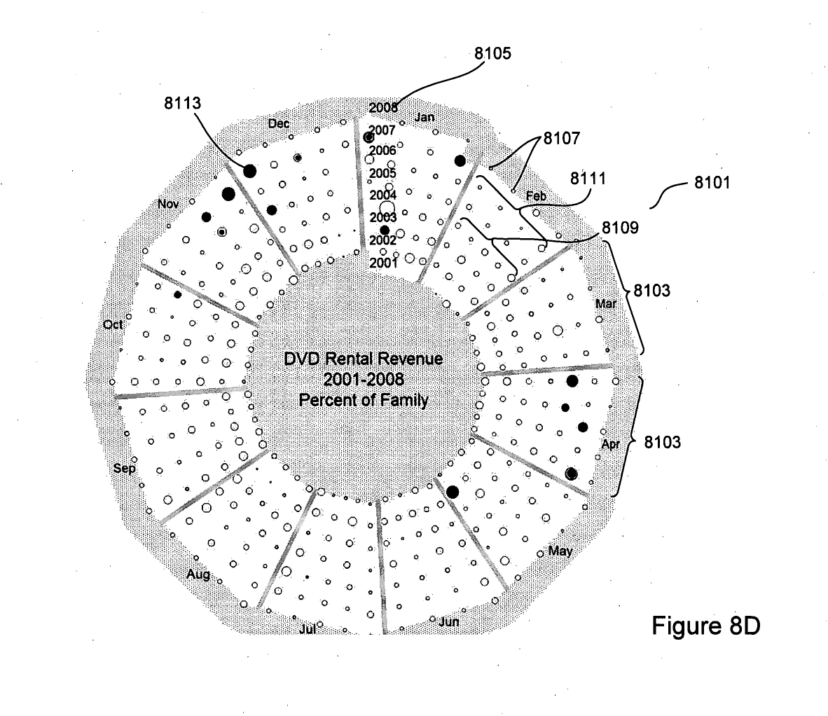

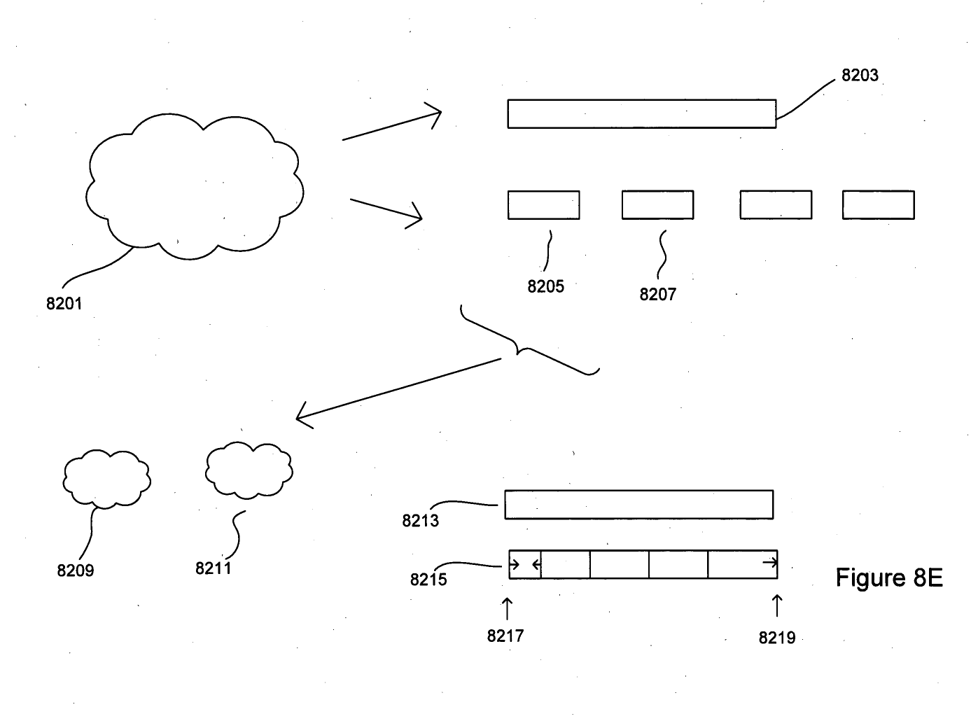

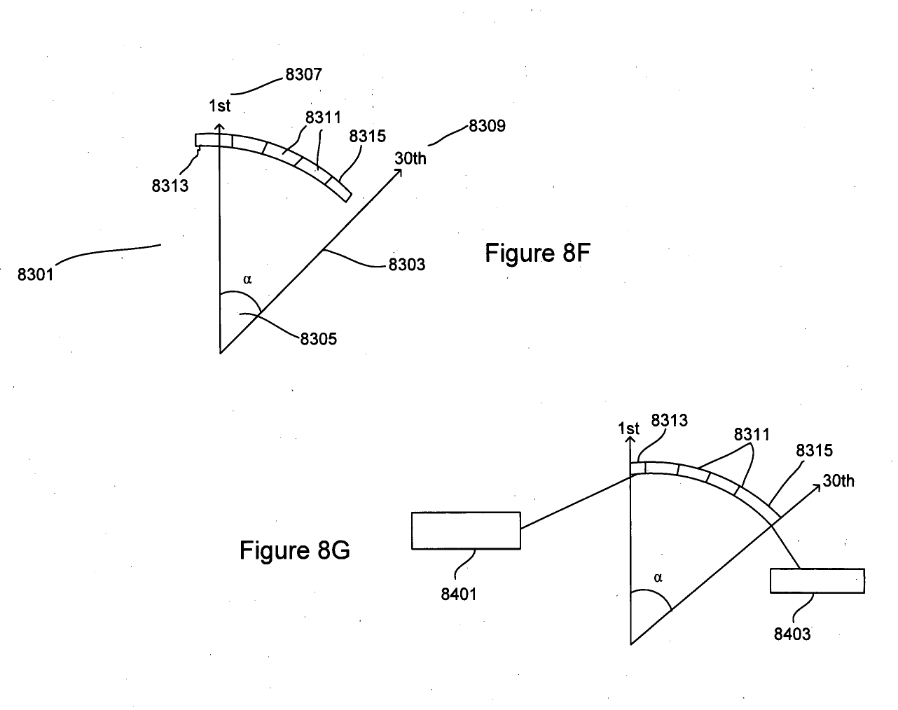

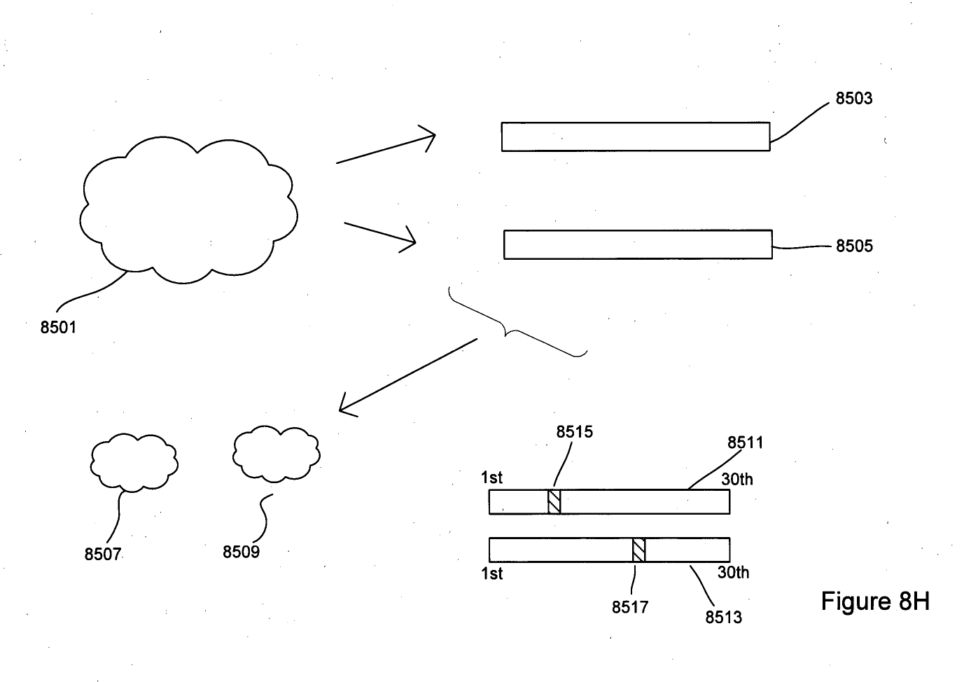

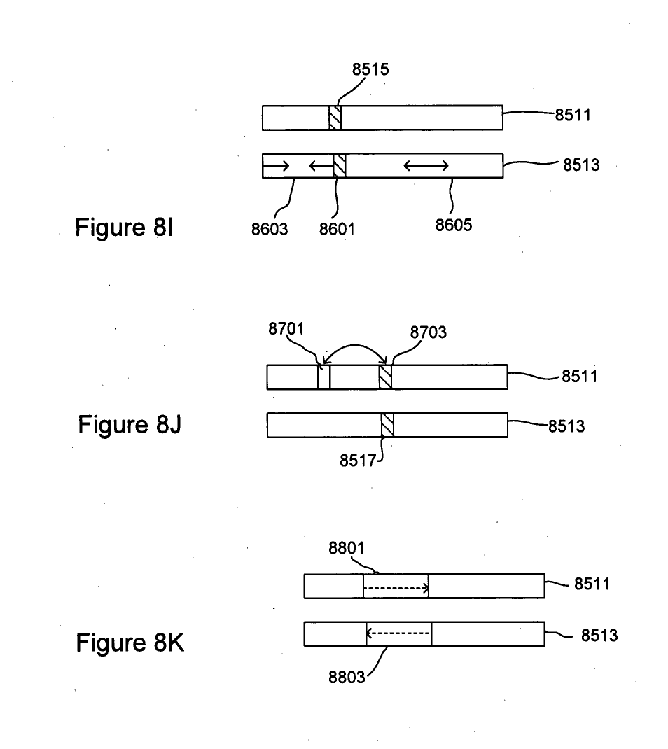

FIG. 8A is a simple illustration showing how data sets for different periods 805 and 810 may be aligned. Event 825 may be aligned with event 830 by making a contraction 815 or 820 (or a portion could be expanded). The degree of contraction or expansion may increase with viewing resolution.

FIG. 8B shows a dodecagon spiral which is useful for displaying data for a number of years 835 and 840, each year being one ring of the spiral. In this case each month is allocated a radial slice of 30° (such as December 845) and contraction or expansion adjustments are made within each month to conform to this constraint. Within months dates may be aligned so that the same dates are aligned for months of different length (i.e. April) or holidays are aligned etc. A heat map 850 may be overlaid to reveal meaning between data for different years (e.g. sales levels or profitability).

FIG. 8C shows a box spiral variant in which the year is broken into four quarters, each represented by a side of a cube: 855 for the first quarter, 860 for the second quarter, 865 for the third quarter and 870 for the fourth quarter. Again each month is allocated a radial slice of 30° (such as December 875). Again heat maps 880 and 885 may be overlaid to reveal meaning between data for different years.

A more detailed description now follows.

Although the following example provides details of aligning weekly periods with monthly periods it will be understood that the inventive concept can be applied to align data of any periodicity with data of other periodicities. For example, in test data and error reporting, the test data sets retrieved may be obtained by the system every 100 minutes using any suitable data measurement technique, whereas, the error reporting may be required by the user to be collated and reported every 24 hours at midnight. Therefore, the system is required to align the data in order to take into account the fact that the 100 minute periods do not wholly fit into any 24 hour segment, and that the start times of the 90 minute periods may not start exactly on the hour.

FIG. 8D shows a dodecagon spiral 8101 produced according to the methods described herein. The dodecagon spiral is represented as a dot density map, where each data point is represented by a dot, or circle. The spiral depicts data on a month by month basis 8103 for a number of different years 8105. The data provided is weekly accounting data 8107 for DVD rentals. Each weekly accounting period is represented by the weekly dots 8107. The data visually represents the spread of the revenue for the periods of interest. The spiral includes 12 months, January through to December, shown in a spiral format. Each month is provided with an approximately 30 degree area of space in which the data is to be represented. That is 360 degrees divided by the 12 months being represented. Each year provides a successive layer on the spiral, where each year that passes is included as an outer layer. That is, the earlier years are depicted as progressing towards the centre of the spiral.

The map shows in a clear format the level of rental activity throughout different time periods of the year. For activity beyond a predetermined limit, a symbol 8113 is provided to represent that activity. For example, if the revenue received for a weekly accounting period exceeds a predefined monetary value, then a circle of a particular dimension is displayed to depict that level of revenue. The circle increases in size for increased activity. A first level is depicted as a circle without any black filling, and a second higher level is depicted as circle with a black filling. Thus, a small black circle represents a higher revenue level than a large white circle, the largest black circles represent the highest revenue levels and the smallest white circles represent the lowest revenue levels.

As each month in each year is aligned, it is possible to see where similar peaks or troughs in activity occur throughout the months and years. For example, it can be seen from the change in map details that DVD rental activity around November and December gradually increased from 2003 onwards for these months, with the same levels of activity shown for April each year, both of these time periods being a key promotional period for the release of movies.

Looking at one particular month, such as February, in a little more detail, the spread of the periodic data can be seen to vary. In 2004, 5 weekly accounting periods are provided as shown by the 5 dots, or circles, 8109. In 2006, only 4 weekly accounting periods are provided as shown by dots 8111. The system determines how many accounting periods are to be allocated to any particular month based on a set of rules. In this way, the weekly periodic accounting periods are aligned with the monthly periods. The different methods of alignment are described in more detail below. Therefore, aligning data sets of one periodicity with data sets of a different periodicity provides a more accurate and repeatable representation of the data to enable a better comparison of data sets.

FIG. 8E shows conceptually how the data is aligned in the data sets by modifying one or both of the data sets. Data 8201 is provided to be analysed and aligned, and optionally graphically represented. The data 8201 includes data of a number of different periodicities. A first periodicity 8203 is, for example, a monthly period. A number of second periodicities 8205 and 8207 are, for example, weekly periods. The data associated with these periodicities is arranged into data sets 8209 and 8211. The data within the data sets may be of any type, for example, the data may be accounting data for DVD rentals as depicted above, or test data retrieved from a manufacturing plant identifying error rates for a particular manufacturing process.

Each data set (8209 or 8211) is arranged according to its periodicity. The monthly data set 8209 is arranged to show the monthly data 8213. The weekly data set 8211, including data for a number of weeks 8215, is arranged to align with the monthly data 8213. The weekly data 8215 will include a first portion of data 8217 for a first week, and a second portion of data 8219 for a final week, where the first and final weeks are aligned with the start and end points of the monthly data 8213. Also included in the result, whether it is a data set output from the system or a graphical representation, is the data for the intervening weeks associated with the relevant month.

The data associated with the first week period and final week period are particularly important as it does not align with the start and end points, of the monthly period.

The system initially analyses the data provided to check the start and end points of the data sets of different periodicities to see if the start and end points of the different periodicities are in alignment and so directly correspond with each other. If the start or end points do align, then no further alignment is required for that point. That is, if the start of the weekly period aligns with the start of the monthly period, and the end of the final weekly period aligns with the end of the monthly period, then no further alignment is required. Clearly this can only occur for periodicities of weeks and months where the month has a total number of days that is a multiple of 7 (the number of days in the week), and so is only relevant in this particular embodiment when dealing with the month of February in a non leap year.

On the other hand, if either of the start and end periods of the data of one periodicity do not align with the start and end points of the data of the second periodicity, the system follows a set of predefined rules to align those points for the different periodicities.

In this example, the data for the first week includes a number of days at the beginning of that accounting week which do not fall into the monthly data due to the dates of those days. For example, the first two dates in the accounting week may be part of a previous month. Therefore, according to one particular rule discussed below, the system aligns the data associated with that week's accounting data so that it fits within the monthly data, regardless of the fact that the dates associated with the initial part of that week's accounting data actually fall into the previous month. In this case, the data for the first two days is compressed into the rest of the data for that week in order to make it align with the start of the monthly data.

Where the last day of the final week period does not fall on the last day of the relevant month, the final week data is expanded so as to fill in the gap that would otherwise exist at the end of the month.

Various other rules may be utilized to provide similar results whereby data of one periodicity is aligned with data of another periodicity.

As described above, a data set of a first periodicity may be restricted or expanded to align with another data set of a different periodicity.

The restriction of the data sets may be by way of compressing, deleting or moving at least a portion of one or other of the identified data sets.

The expansion of the data sets may be by way of adding new data to a data set, padding out the data set with zeros, arbitrary values, average values or extrapolated values. Further, at least a portion of one of the data sets may be moved in order to effectively expand the data set that is to be aligned. Alternatively, data from another different data set having the same periodicity may be included in the data set being aligned.

In the case where the data is being extracted from a manufacturing system for analysis purposes, such as for example in a testing environment where test data is being analysed to detect the results of a manufacturing process, the original data sets being analyzed may be replaced by aligned data sets in order to allow more accurate data analysis of the results retrieved from the manufacturing process. The aligned data sets may permanently replace the measured data sets, or be stored alongside the original data sets, within a database in communication with the manufacturing system. Further, the data associated with the aligned data sets may be fed back into an analytical system that determines an appropriate response, or the data may be used to provide an output to alter the manufacturing process, based on the analysis of the aligned data. In this way, the manufacturing process can be more accurately controlled through the creation and provision of more appropriately aligned periodic data to the analytical unit.

In addition, or alternatively, the system described herein can provide a graphical representation of the different data sets after they have been aligned. That is, rather than changing the associated data, the system may only modify the graphical representation of the data to align the periods.

FIGS. 8F and 8G show one example of how a graphical representation may be adjusted to visually align a data set of one periodicity with one or more data sets of another different periodicity.

FIG. 8F shows a portion of a graphical representation 8301 of sets of data having different periodicities, where the present invention has not been applied. This example shows a spatial area 8303 of a dodecagon spiral allocated to represent the data associated with a single month. It will be understood that graphical representations other than a dodecagon spiral may be used. One non limiting example is that a box spiral may be used.

The slice is represented over an area spread out from a centre point at an angle of 30 degrees 8305 to cover the 12 months of the year evenly over the 360 degrees available. The start of the month (i.e. the 1st) is at a start point of the area 8307, and the end of the month (for example, the 30th) is at an end point of the area 8309. Also in this example are represented data sets of a weekly periodicity 8311. The first weekly data set 8313 can be seen to overlap with the spatial area 8303 so it also enters, or is part of the previous month, and the last weekly data set 8315 can be seen to sit within the area, but leaves a gap between the end of the weekly data set and the end of the month. Therefore, the weekly accounting period data sets do not align with the monthly period data sets.

Referring to FIG. 8G, an aligned graphical representation of two data sets having different periodicities is shown. It can be seen that the first weekly data set 8313 has been modified to align the start of the weekly data sets associated with the start of the graphical representation of the monthly data set. The interim weekly data sets 8311 did not require any modification as it sits wholly within the monthly representation. The final weekly data set 8315 has also been modified to close the gap previously shown in the monthly graphical representation. In this example, the graphical representation of the weekly data set has been condensed in order to align it within the spatial area allocated for the monthly data representation. The method of condensing may be by way of reducing the size of the graphical representation along one or more of the axes of the representation. Alternatively, the method of condensing may be by way of deleting at least a portion of the weekly data set to provide the condensed graphical representation of the weekly data set. It will be understood that condensing may include one or a combination of constricting, compressing or compacting the data or representation.

In this example, the graphical representation of the final week's data has been expanded in order to align the representation with the available spatial area of the monthly representation. The method of expansion may be, for example, by extending the size of the graphical representation of the weekly data set along one or more axes. Alternatively, new data may be added or inserted as part of the graphical representation to provide an extended graphical representation of the weekly data set. The new data added may be arbitrary data, average data, interpolated data, extrapolated data, data of a similar nature from a different data set or any other data that the user selects for the purpose of alignment.

Also, the graphical representations of the first periodicity may be aligned with the second by moving the graphical representation of the weekly data set so that it is aligned with the spatial area allocated to the monthly data set. Further, the data within the weekly data set may be moved or swapped with another weekly data set.

As can be seen on FIG. 8G, supplementary information 8401 and 8403 may be displayed alongside the graphical representations of the data. The supplementary information may include information associated with one or both of the first or second identified data sets. For example, the supplementary information may identify and label the different periodicities of the two different data sets, and may provide more information as to the relationship between the two. Also, the supplementary information may include information associated with the methods used to align the two data sets.

The above described methods therefore show the distortion of a graphical representation of a first data set of a first periodicity to align it to a second data set of a second different periodicity. The degree of distortion may be increased as the graphical representation of the first identified data set is viewed at increased granularity by the user. That is, as the user zooms into the representation of the examples shown, it may be seen that the daily data sets do not accurately align with the weekly data sets due to the timing of the data retrieval, i.e. the end of day finishes at a time other than midnight. In this case, either the daily data sets or weekly data sets may be adjusted to align the two as the user zooms into that level of granularity.

Although the examples above have described the adjustment of the data or graphical representations of the weekly periodicities or daily periodicities to align with the monthly or daily periodicities respectively, it will be understood that the data or graphical representations of the monthly or daily periodicities could, as an alternative, be adjusted to align with the weekly or daily periodicities respectively.

FIG. 8H shows conceptually how periodic events are aligned in data sets in which they occur, by modifying one or both of the data sets. Data 8501 is provided for analysis to detect the periodic events and the periodic data sets in which the events occur, as well as other periodic data sets. The aligned data sets may optionally be graphically represented or stored for control purposes. The data 8501 includes groups of data sets, where in one group are monthly data sets 8503 for a particular year and in another group are monthly data sets 8505 for another year, where those data sets have the same periodicity. The periodicity of the data sets 8503 and 8505 may be, for example, a monthly period. The data associated with particular months is arranged into data sets 8507 and 8509. The data within the data sets may be of any type, for example, the data may be accounting data for DVD rentals as depicted above, or test data retrieved from a manufacturing plant identifying error rates for a particular manufacturing process.

Each data set (8507 and 8509) is analysed to identify instances of the periodic event, and the position of the periodic event within the data set. For example, a first data set 8511 of a monthly periodicity, for example April 2004, and a second data set 8513 of a monthly periodicity, for example April 2003, is shown. Also identified are the instances of the regularly occurring Easter Sunday that occurred in each of those periodicities. In the first data set, Easter Sunday 8515 occurred on 11 Apr. 2004, whereas in the second data set, Easter Sunday 8517 occurred on 20 Apr. 2003. In this example, the alignment is made relatively easier due to the two monthly data sets being associated with the same month (i.e. April), or in the same relative position within the group of data sets, where each group is for a year. Examples are also provided below to show how the system operates to align periodic events when they occur in groups that aren't associated, or aren't in the same relative position within the group of data sets, for example, when Easter does not occur in the same month.

FIG. 8I shows an example of aligning data associated with a periodic event within two different monthly data sets 8511 and 8513. It will be understood that the alignment or the adjustment discussed herein may be by way of aligning a graphical representation, or changing the actual data in storage in order to use the data for analytical purposes, such as in a manufacturing environment using test data where, for example, the periodic event is a shut down of a machine for maintenance purposes.

In the example shown in FIG. 8I it can be seen that the data set 8511 and position of the data associated with Easter Sunday 8515 is unchanged. However, the relative position of the data for Easter Sunday 8517 in data set 8513 in FIG. 8H has been moved to position 8601 in FIG. 8I. The data has been moved by adjusting the data in portions 8603 and 8605. In the data analysis embodiment, the data associated with portions 8603 and 8605 are adjusted to cause alignment, whereas in the graphical representation embodiment the actual data associated with these portions may or may not be adjusted and the alignment may be realized by merely adjusting the graphical representation alone.

The following provides the description associated with data analysis and adjustment without providing a change in the graphical representation of the data. However, it will be understood that the methods described in this section may be applied in conjunction with the methods described below for the adjustment of the graphical representation of the data.

In this embodiment, the data within the first portion 8603 and second portion 8605 of the data set 8513 associated with the first instance of the event is modified to align the first and second instances of the periodic event. For example, the first portion of the data set 8603 may be restricted. Alternatively the second portion of the data set 8605 may be expanded. Further, both an expansion and restriction of different portions of the data sets may be carried out.

The restriction of the data within the data sets may be carried out by compressing at least a portion of the data within that data set. Alternatively, at least a portion of the data maybe deleted or moved.

The expansion of the data within the data sets may be carried out by adding new data to the data set. For example, the data set may be padded out by including null or zero values, average values, extrapolated values, interpolated values, arbitrary values, values from a similar data set, or any other data values that the user selects for the purpose of alignment.

In this way, the data associated with the first instance of the periodic event (Easter Sunday) can be aligned with the data associated with the second instance of the periodic event by restricting and expanding various portions of the data to align the events.

Alternatively, as shown in FIG. 8J, a portion of the data within the data set may be moved within the data set in order to align the data associated with the event. The data associated with the event 8701 in the first data set 8511 is moved to a new position 8703 by swapping the data for that Easter Sunday with the data for the day that aligns with the Easter Sunday in the other data set 8513.

Alternatively, the system may determine the two boundaries between the periodic events and average out the data between those boundaries in each of the two data sets containing the instances of the periodic event. Referring to FIG. 8K, a portion of data in the data set 8511 is averaged out over the region 8801 starting at the first identified instance of the event and ending with an equivalent data position for the second identified instance of the event. The same is applied to the second data set 8513 to average out the values over the region 8803 up to an equivalent data point that aligns with the first instance of the event 8515.

Also, the modified data set with the first instance of the periodic event may be analyzed in conjunction with the other data set containing the second instance of the periodic event in a manner that takes into account the aligned data. Thus, the analysis is not carried out on comparatively spurious or inaccurate data and so enables a more accurate analysis.

Once the analysis has been carried out, the original data set may be replaced by the modified data set or may be stored alongside the modified data set.

Any number of identified data sets may be aligned relative to one or more other identified data sets. Further, the step of aligning data sets may include the step of aligning a start period of a first data set with the start period of another data set. Also, the step of aligning may include the step of aligning an end period of a first data set with an end period of another data set. Further, both the start and end periods of the data sets may be aligned to enable the whole of one period to be aligned with another period.

During the step of aligning, the determination module of the system may first determine whether the first data set is wholly encompassed within another data set.

If the determination module does not determine that a first data set is wholly encompassed within another data set, the system may align the first data set so that it is wholly encompassed within the second data set.

Also, the system may modify the first data set so that it aligns with the second data set. This may include restricting the first data set so that it aligns with the second data set. The restriction may be by way of compressing, deleting or moving at least a portion of the first data set.

Also, the system may modify the first data set by expanding it so that it aligns with the second data set. This expansion may be by way of adding new data to the first data set. For example, the new data may include one or a combination of null values, average values, extrapolated values or interpolated values. Alternatively, the expansion may be by way of moving at least a portion of the first data set or including at least a portion of a further data set that the system has detected as having the same periodicity as the first data set.

The system may go on to perform any suitable analysis of the data set once it has been modified or adjusted by the system. Further, the system may replace the original data set with the modified data set.

It will be understood that the periodicity detected by the system may be associated with any period that can be measured. For example, the periodicity may be time related or calendar related.

Further the system is able to determine a lowest common time base from the periodicities that have been determined from the data sets. This enables the system to then base the first data set on this determined lowest common time base. For example, if the minimum time base in the analyzed data sets is in fortnightly testing periods, then this becomes the common time base by which the data sets are aligned.

The following describes how the system changes the graphical representation of the data sets in order to adjust and align the periodic events graphically or visually. However, it will be understood that the methods described in this section may be applied in conjunction with the methods described above for the adjustment of the data in the data sets.

In the herein described data visualisation or graphical analysis system, the modified data sets are arranged so that the graphical representation of a periodic event aligns with the graphical representation of other instances of the same periodic event. This graphical alignment ensures that the user can view the appropriate data associated with the events (and surrounding periods) in the correct context.

The graphical representation may be of any suitable form for graphically representing temporal data. For example, the representations may be in the form of a spiral calendar, a box calendar etc.

The system implements various steps to align the graphical representations of the data, for example by controlling a condensing module that is arranged to adjust or condense the graphical representation of a data set so that a first instance of a periodic event aligns with a second instance of the periodic event. The adjusted or condensed version of the representation is output in a visual form, such as on a graphical user interface, display, printer etc.

This adjustment or condensing step may include one or a combination of the steps of constricting, compressing or compacting the graphical representation.

Further, the adjustment or condensing step may include the step of reducing the size of the graphical representation of a data set along one or more axes of the data set. For example, the condensing module may reduce the x or y (or both) dimensions of the graphical representation in order to align the data sets.

Further, the adjustment or condensing step may include the step of deleting at least a portion of a data set to provide a condensed graphical representation of the data set. For example, by deleting a portion of the data set or representation, the periods in the representation become fully aligned.

Alternatively, an expansion module may be controlled by the system to enable the graphical representation of a data set to be adjusted or expanded so that a first instance of a periodic event is aligned with a second instance of the periodic event. Further, the adjustment or expansion step may include the step of expanding the size of the graphical representation of a data set along one or more axes of the data set. For example, the expansion module may increase the x or y (or both) dimensions of the graphical representation in order to align the data sets.

The extension of a data set by the extension module may be achieved by inserting new data into a data set in order to provide an expanded graphical representation of the data set.

Alternatively, the extension may be achieved by moving at least a portion of the graphical representation of a data set so that a first instance of a periodic event aligns with a second instance of the periodic event. For example, data may be moved from within a first data set to a further data set that has the same periodicity as the first data set.

The graphical representations discussed above may be of any suitable form for displaying temporal information. For example, the graphical representation may be a dodecagon spiral or a box spiral. Further, the data sets may be displayed in any suitable form, for example by being graphically represented in two or more calendar systems.

Further, the various different data sets may be displayed in a hierarchical manner to indicate their temporal relationship with each other, for example.

The system described above may retrieve further information associated with the data sets in the form of supplementary information. This supplementary information is used to display related information on the same visualization. For example, the supplementary information may be used by the system to identify on the graphical representation the different periodicities associated with the various data sets. Alternatively, the supplementary information may include information associated with how the first and second event instances of the periodic event are aligned, i.e. information that indicates which methods were used by the various modules of the system to align the data.

It will be understood that the complex system described above includes one or more elements that are arranged to perform the various functions and methods as described herein. The following portion of the description is aimed at providing the reader with an example of a conceptual view of how various modules and/or engines that make up the elements of the system may be interconnected to enable the functions to be implemented. Further, the following portion of the description explains in system related detail how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose computing system specifically programmed to perform the described steps. Alternatively, the methods described herein may be implemented using a specific computer system such as a data visualization computer, a database query computer, a graphical analysis computer, a gaming data analysis computer, a manufacturing data analysis computer, a business intelligence computer etc., where the computer has been specifically adapted to perform the described steps on specific data captured from an environment associated with a particular field.

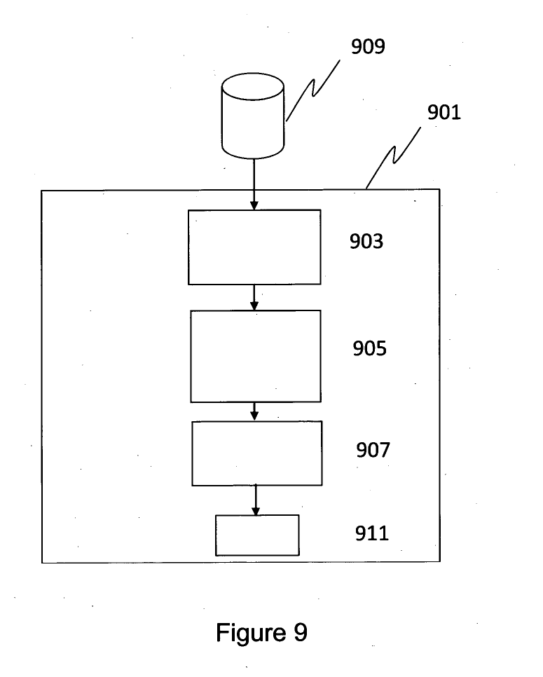

According to this embodiment there is shown in FIG. 9 a conceptual system diagram where a graphical analysis computing system 901 includes at least the following elements, a data retrieval module 903, a periodicity determination module 905 and an alignment module 907.

The data retrieval module is configured to enable the retrieval of data from a data storage module 909, which is in communication with the graphical analysis computing system. The data storage module may be any suitable type of data storage system. For example, it may be an enterprise data warehouse (EDW), a data mart, a database, a storage array or any other suitable device or groups of devices that can store data for later retrieval. Further, the data storage module may be a cache memory used to temporarily store incoming data captured in real time.

The data provided as an input to the system may be any suitable type of data, for example, real world data including, but not limited to, gaming or gambling data associated with a gaming environment such as a casino, event data, test or quality control data obtained from a manufacturing environment, business data retrieved from an accounting system, sales data retrieved from a company database, etc. All this data may be received by the system in real time within a cache memory or may be stored in a more permanent manner prior to it being analyzed.

The data may be retrieved from the data storage module by the data retrieval module 903 using any suitable known technique, such as, for example, SQL statements.

Further, the alignment module 907 may be in communication with a display module 911 that is specifically adapted and controlled by the system 901 to display the output of the alignment module in a graphical manner.

As an alternative to, or in conjunction with, the display module, further output modules may be provided to output the results of the alignment module. That is, the raw data retrieved by the data retrieval module is analyzed and converted to provide output data in a specific format. The output data is provided to the display and/or further output modules to enable a user to visualize the raw data in a manner that conveys more useful or hidden information that would otherwise be lost.

The further output module may be a printing device in communication with the described system to receive print control data so that representations of the data may be printed on any suitable print medium. Alternatively, the further output module may be an interface that enables the data output from the alignment module to be interfaced with other data handling modules or storage devices. The retrieved data is processed by the periodicity determination module 905, which determines whether there are a number of different periodicities within the retrieved data. Based on the different periodicities detected, data sets are identified where each data set is associated with a specific period.

These identified data sets are then aligned by the alignment module as herein described.

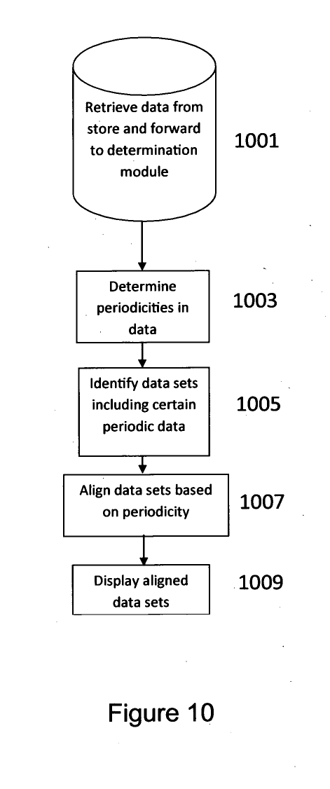

FIG. 10 shows a flow diagram of the method steps carried out by the system. The steps include at step 1001 retrieving data from the data store and forwarding the data to determination module. At step 1003, periodicities in the data are determined. At step 1005, data sets with certain periodicities are determined. That is, for any data set, the system determines which periodicities occur within the data of that data set. At step 1007, the data sets are aligned based on the periodicities of the data within the data sets. At step 1009, the aligned data sets are provided as an output, such as being displayed on a graphical user interface.

Alternatively or in combination with the above example, the retrieved data may be processed by the periodicity determination module 905 to identify whether the data sets include instances of a periodic event. The alignment module may then align the data associated with each of the identified periodic event instances relative to each other.

The graphical analysis computing system 901 is controllable by any suitable pointing device operated by a user. The user may therefore select an identified data set that is displayed on the display module 911 in order to view that data set at an increased granularity. For example, the data sets shown may have periodicities of weeks and months, whereas the user may wish to drill down into one of these data sets to see other shorter periodicities, such as days, hours, minutes or other non naturally occurring periodicities that are not directly linked with the sun such as a specific machine testing period or business accounting period, for example.

By selecting one of the displayed data sets, the periodicity determination module can analyse the data within the selected data set and determine which other periodicities are present within the selected data set.

Once the periodicity determination module has identified the further data sets of an increased granularity, the identified data set may then be aligned by the alignment module with one or more of the other identified data sets.

The alignment of these new data sets may then be displayed on the display module. In this manner a user is able to drill down into the data using the graphical user interface and see the aligned data sets at each level of granularity.

The periodicity determination module may be programmed, controlled or adapted either by the user or developer to determine a specific period or set of periods. For example, the user may select from a drop down menu which individual or groups of periods or types of periods the periodicity determination module is required to search for in the retrieved data.

The periods may be changed so that the periodicity determination module may determine periods of time, such as, for example, any time period selected from a multiple, whole or portion of a second, minute, hour, day, week, month, or year.

Alternatively, the periodicity determination module may be controlled to determine a multiple, whole or portion of a calendar period, such as a multiple, whole or portion of a day, week, month, year, leap year, decade, century for example.

Further, the periodicity determination module may be controlled to determine a social period such as a weekend or holiday period etc. Further, the periodicity determination module may be controlled to determine a business period such as, for example, an accounting period, sales target period etc.

In relation to events, periodicity determination module may be controlled to determine periodic business related events, such as a product launch event, for example. Also, the event may relate to a level of completion of a business event, such as, for example, how far a certain business project has been completed.

Alternatively, the periodicity determination module may be controlled to determine periodic cultural events, such as, for example Labor Day or May Day etc. These cultural events may be a measure of cultural development.

Further, the periodicity determination module may be controlled to determine periodic religious events, such as, for example, Christmas, Easter, Passover etc.

Further, the periodicity determination module may also identify two separate instances of the periodic event within two different data sets having the same periodicity. The periodicity determination module is then arranged to determine the relative positioning of each of the events in the different data sets.

For example, if the periodicity determination module determines that a first data set is in a different relative position to a second data set, then the alignment module is instructed to align the two data sets, and the alignment module aligns the data associated with the first instance of the periodic event in the first data set with the data associated with the second instance of the periodic event in the second data set.

Alternatively, if the periodicity determination module determines that the first data set is in the same relative position, the alignment module is instructed to align the data associated with the first instance of the periodic event in the first data set with the data associated with the second instance of the periodic event in the second data set.

The alignment module may modify the data within the first data set associated with the first instance to align the first and second instances of the periodic event.

The modification step may be in the form of restricting, compressing, deleting, moving or expanding at least a portion of the data within the first data set to cause alignment.

The step of expanding the data may be implemented by the alignment module adding new data into the data set, such as one or a combination of null values and average, extrapolated or interpolated values for the original data set.

Alternatively, the step of expanding the data may be implemented by the alignment module moving at least a portion of the data within the first data set.

Alternatively, the step of expanding the data may be implemented by the alignment module including within the first data set at least a portion of a further data set that has been identified by the periodicity determination module as having the same periodicity as the first data set.

In a further embodiment, the system herein described may allow queries (such as database queries, for example) to be constructed against data sets having different periodicities. This temporal query computing system enables the determination of the different periodicities within the data sets of the data that is retrieved. A data set query, such as a query written in a database query language, for example SQL, may be analysed, and the temporal parameters within the query may be determined by any suitable mechanism, such as parsing. The system may then resolve the temporal parameters in the query and create data sets according to the resolved parameters.

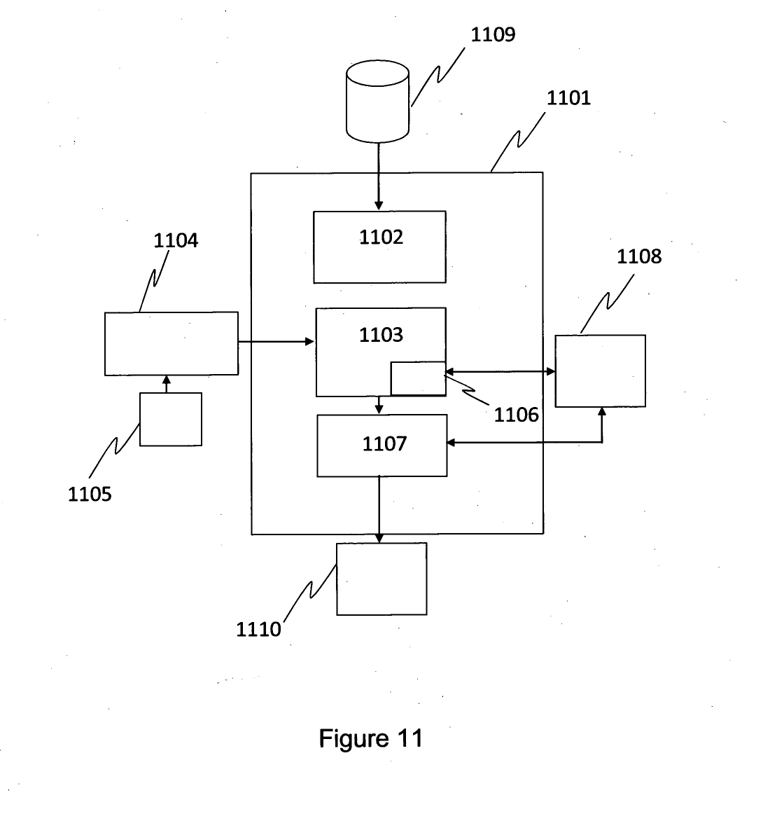

The temporal query computing system of this embodiment is arranged to provide a method of constructing queries against data sets having different periodicity. As shown in FIG. 11, the temporal query system 1101 forms part of the herein described system, and in its basic form includes at least the following modules. A determination module 1102 that is instructed to determine the periodicity of the data sets that are, or are likely to be, referenced in the query. The data sets are retrieved from a storage module 1109, which may be any suitable type of storage system as described herein.

Data queries are provided to a query resolving module 1103 from a query module 1104 that receives data queries from a source 1105. The source may be a graphical user interface where a user enters queries manually, another module within the system or from a different system. The queries may be of any suitable format, for example an SQL format.

A query resolving module 1103 then resolves the temporal parameters passed in the query. The temporal parameters may be resolved by an interpretation/parsing engine 1106 that is arranged to read the components of the query and either interpret or parse the pieces relevant to the temporal parameters. The interpretation/parsing engine may retrieve, from any suitable storage medium, specific knowledge of temporal functions such as month of year, day of week or other date functions. The resolving process results in the construction of a query that includes temporal components. This query may be written in SQL and submitted to a relational database 1108.

A data set creation module 1107 is arranged to create data sets according to the resolved temporal parameters provided by the query resolving module 1103. The data sets may be created by submitting SQL statements to a relational database 1108 or by combining the results of several, database queries.

The output from the data set creation module 1107 may then be forwarded to any suitable output device 1110, such that the resultant data sets can be stored, analyzed, displayed, interpreted or processed.

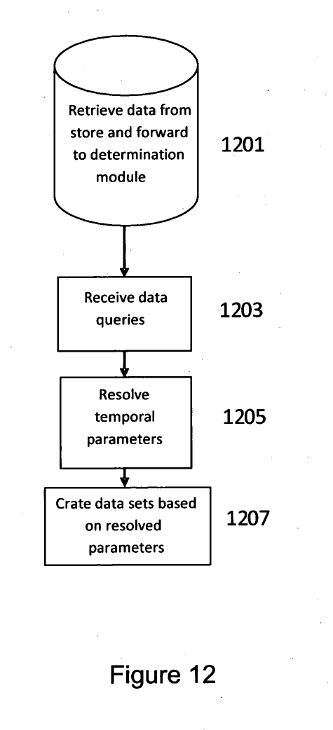

Therefore, as shown in FIG. 12, the system performs the following steps:

At step 1201, the data sets are retrieved from the data store. At step 1203, data queries are provided to the system.

It will be, understood that the steps 1201 and 1203 may be carried out in a different order, where 1203 is carried out before 1201, or substantially simultaneously with 1201.

At step 1205, the temporal parameters in the query are resolved. At step 1207, data sets are created based on the resolved parameters.

According to one example, the temporal parameters in the query may be times in different time zones.

It will be understood that the query resolving module may use an extension of SQL to calculate temporal or relationship functions, and so build the queries. Also, the query resolving module may use metadata to provide sensible or common-sense defaults in order to calculate temporal or relationship functions for the interpretation of results.

The query resolving module may include a rules engine that is used to resolve queries giving an answer that is most likely to be correct based on a set of rules applied to the engine.

The system can be adapted to use an extended set of SQL statements (i.e. they extend beyond the basic functions) to build a SQL language where they resolution of the temporal functions and relationships are expressed in the language and executed in a database engine that understands the query. Therefore it can be seen that visual or query results may be produced as a result of an extended SQL query against an extended relational database.

The temporal parameters in the query may be resolved using any of the techniques described above, wherein the temporal parameters are aligned through modification, restriction or expansion of the temporal parameters.

According to one example, the input parameters may be times in different time zones, and so an alignment is required to ensure the query takes this into account when accessing the database and retrieving the associated data set that answers the query.

A method of resolving a query is therefore provided wherein the temporal components of the query are arranged to handle the non linear nature of time. This differs from traditional queries as the user can run SQL statements where concepts such as financial account period, Chinese New Year, and Easter are understood by the database engine. This understanding enables the results to multiple temporal sequences to be provided in an efficient manner.

The SQL Statement may be made up from any suitable SQL definitions, including, for example, any of the following clauses:

### Select Clause

The “select” clause may include results such as count of number of Easters, or days since Chinese New. Year, for example.

### From Clause

The “from” clause enables specific tables to be included in the query. These tables have an implicit understanding of the temporal non linear nature of time.

### Join Clause

A table may be joined together using the non linear temporal rules. For example join together sales based on weeks including a religious holiday.

### Where Clause

A restriction may restrict with questions that require implicit knowledge of one or more temporal sequences. For example, select the years where a full moon is within 3 days of Easter.

### Having Clause

A “having” clause can be adjusted to answer temporal questions such as where the sum of revenue for is greater than XX on Christmas days that occur on a Sunday.

### Group By Clause

Group by is extended such that the queries have implicit understanding temporal queries. For example group by year can now include Chinese calendar years.

Alternatively they can produce a set of results one for each interpretation of calendar year.

### Order By Clause

Order by is extended such that queries can be ordered by multiple temporal sequences, producing an array of results. For example order by months and weeks produces two sets of interrelated results where both sequences are correctly calculated.

Further examples of SQL definitions may be found at http://en.wikipedia.org/wiki/SQL.

The forgoing methods may further include a hierarchical display of the data sets using a related method, such as a tree method.

These methods may be interactive methods assisting an end user to construct one or more graphical representations of data and/or their underlying attributes with multiple layers of elements that include shape, position, color, size, and animation. This may assist an end user to organize the graphical representations in such a way as to contribute to the end user's understanding of the data represented including assisting an end user to use proportion and positioning to compare temporal events within periods that contain disparate elements.

This type of visual design is a completely data defined Visual Design. The key input values are typically ‘start’ and ‘end’ dates along with the ‘number’ of variables to be displayed.

The simplest, and potentially the most useful, Visual Design Special Layer may be a carefully drawn calendar. The calendar may then become a useful Visual Design for date-based Visual Documents.

Temporal analysis is one of the fundamental methods of almost all analysis. Using temporal high density visualizations, users will be able to overlay high density Thematic Layers on well designed Special Layers such as the spiral data visualization shown in the above examples. This analysis can be applied in everything from customer frequency and spend analysis to analysis of the impacts of time of day on the management of a mobile phone network.

It is considered that temporal design patterns are particularly important in terms of analytics as the majority of analytics are time based. Described herein are several examples of producing temporal visual designs.
Non Contiguous Time—For example, weekends can be represented in some interesting ways. The simplest way being not to show them.
Non-linear Time—This allows multiple years of history to be shown where the oldest data is spatially compressed in the Visual Design.
Temporal Special Layers—These can be used to compare quite disjointed types of data. For example, the relationship between external public events, operational payroll sizes and sales revenue. There exists no easy way to numerically join this data together, visually this data can be joined. The technique combines well with simple correlations as it is possible to combine these distinct datasets to show correlations.
Control—One important consideration in visualizing temporal data is the gaining of scientific control. For example, seasonal variables. This is particularly interesting as one year is always different from the next. Quite simply, the start date of each year is never the same as the next, and moving external events such as Easter and ‘acts of God’ such as weather make precise comparison very difficult.

### Time Selection

The described solution will inherently eliminate the concept of system time. Visual Documents will typically be generated using either one relative time or one local time definition:
Relative time Visual Documents—data is displayed at the actual moment it occurred. So data for a Visual document at 5 a.m. Pacific Time would show data from 8 a.m. Eastern Standard Time.
Local time Visual Documents—data is displayed at their local date and time. So data for 5 a.m. Pacific Time would be shown along with data for 5 a.m. Eastern Standard Time.

A useful Visual Document would be to provide a visual comparison of different calendars. For example, the Hebrew calendar to the Gregorian calendar. This would enable comparison of a dataset, to say Julian dates.

The Julian day or Julian day number (JDN) is the integer number of days that have elapsed since the initial epoch defined as noon Universal Time (UT) Monday, Jan. 1, 4713 BC in the proleptic Julian calendar. That noon-to-noon day is counted as Julian day 0. Thus the multiples of 7 are Mondays. Negative values can also be used, although those predate all recorded history. Source: Wikipedia^{x}.

Date and time are very subjective descriptions, and in the real world the way that the date is determined has an impact on its results. For example, the third Monday of a month is quite different to the 18^{th} day of the month as the 18^{th} day can be on any day of the week.

The described solution understands the following concepts:
1. Time zones
2. Precision
3. A Point in Time
4. Local Time
5. Time Definitions. For Example, 3rd Monday of the month, 4th Business day of the month, quarters, half years, Wal-Mart week, gaming day.
6. Special days. For example, Easter.
7. Relative days. For example, Saturday before Christmas.
8. Seasonal periods e.g. summer, winter, fall, spring
9. Conversion between multiple times. For example, local date/time of observer vs. observed.
10. ISO 8601:2004 Week Numbers.

These concepts of time are used in BPDs to produce meaningful Visual Documents.

Heatmaps have a widespread impact on visualization. This section describes the impacts of heatmapping and how it can be imbedded into various applications.

Heatmaps may produce organic shapes representing the data. These organic shapes provide two principal benefits to the consumer of the visual analytics. The first benefit is that they enable higher density of data to be displayed; secondly they lend themselves to animation.

Advantages of using heatmaps may include the ability to:
1. Show 10 times more data than other methods;
2. Enable animation as data is absorbed by users very rapidly;
3. Display heatmaps on most visual designs;
4. Provide generic functionality (for example, zoom; drill-down) that applies to most Visual Designs.

A preferred method of providing the overlay view is to use a semi transparent overlay similar to what will be done to overlay heatmaps on Google™.

One important technique with overlay may be to fade the color or intensity in the background tree so that the visualization data is highlighted.

The user requests that a Visual Document is generated. The rendering engine reads the appropriate metadata required to be selected from the database and then renders the multi-layered output using the defined Visual Document.

The user's request may be split into smaller requests by using the herein described parallelism engine. The rendered Visual Documents are then stored for later use.

For example, the rendered images may be printed, visually displayed on a screen transferred to a permanent storage medium or transferred to another system etc.

Further, it will be understood that the visual representations produced by the herein described system are specifically adapted to enable the visual representation of complex data in order to convey useful information while minimizing the use of production printing materials or limiting the space in which the information may be conveyed. That is, by enabling the herein described system to produce a visual representation that has one or more characteristics as described to summarize a complex problem or complex data, a number of technical advantages are immediately provided. For example, the characteristics of the visual representation may include the limitation of the size of the visual representation, the use of a minimum amount of ink, or the creation of the representation using a minimal or bounded area space or minimum amount of time. These characteristics then may solve one or more problems such as the excessive consumption of consumable items by reducing the required consumption of consumables such as paper and ink resources, as well as reducing the energy required to produce the printouts of the visual representations or the displaying of the information on a display module due to the ability to provide the required information in a visual space of a smaller size.

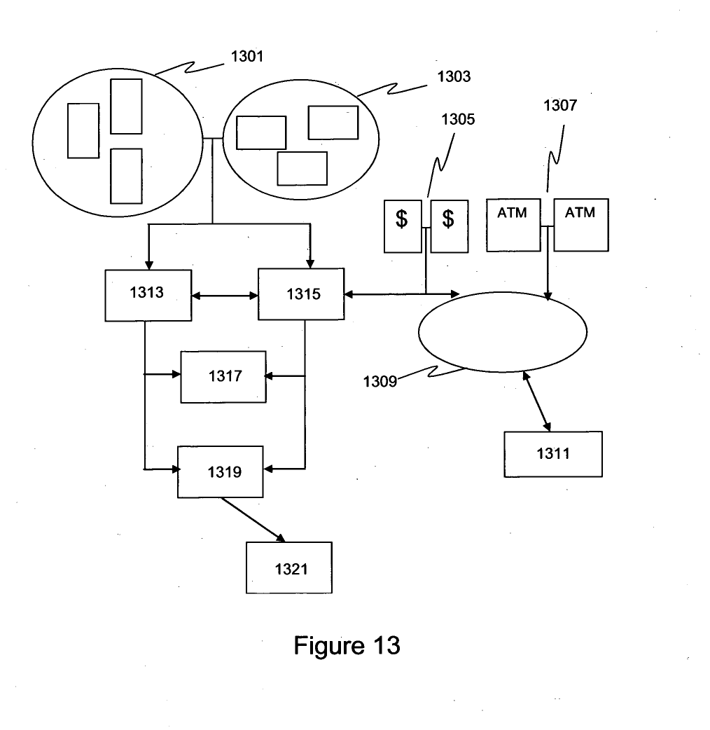

FIG. 13 shows an example of how the herein described system may be incorporated within a gaming environment. The gaming environment consists of a number of gaming machines 1301 and electronic tables 1303 (among other electronic gaming devices) that are adapted to communicate electronically with other systems using any suitable protocols, such as data packet protocols.

The gaming environment further includes a number of electronic cashier devices 1305 and ATMs 1307 which are in communication via a Wide Area Network 1309 with one or more financial databases 1311.

Data from the gaming machines 1301 and electronic tables 1303 are transferred to a reward program database 1313 and customer database 1315. It will be understood that these two databases may be combined into a single database.

Data from the cashier devices are also transferred to the reward program database 1313 and customer database 1315. The databases 1313 and 1315 are in communication with a central hotel management system 1317 that oversees the operation of the gaming environment, including the activities of customers in other areas of a casino, such as shops, hotels, spas etc.

The system 1319 described herein is in communication with the reward program database 1313, customer database 1315 and central hotel management system 1317 so the system can retrieve all necessary data about the activities within the gaming environment. The various embodiments as described herein are employed by the system 1319 to provide an output 1321.

### Glossary

| Term | Definition |
|---|---|
| Agile | Agile software development is a conceptual framework |
| Development | for software engineering that promotes development |
| | iterations throughout the life-cycle of the project. |
| | There are many agile development methods; most |
| | minimize risk by developing software in short amounts of |
| | time. Software developed during one unit of time is |
| | referred to as an iteration, which may last from one to |
| | four weeks. Each iteration is an entire software project: |
| | including planning, requirements analysis, design, coding, |
| | testing, and documentation. An iteration may not add |
| | enough functionality to warrant releasing the product to |
| | market but the goal is to have an available release |
| | (without bugs) at the end of each iteration. At the end of |
| | each iteration, the team re-evaluates project priorities. |
| | Wikipedia^{xi} |
| BPD | A BPD Package is made up from a set of related BPDs. |
| Packages | This relationship (between a BPD Package and its BPDs) |
| | is defined using metadata. |
| | BPD Packages can be thought of as the Visual |
| | Document's vocabulary. |
| Catalog | The described catalog is used to store permanent and |
| | temporary objects that are necessary for creation and |
| | storage of Visual Documents. These may include Visual |
| | Designs, BPDs, Configuration tools and other objects. |
| | There may be multiple catalogs of different types (such as - |
| | database, flat file) which are configured by an integrator - |
| | dependent on customer requirements. |
| | All items in a catalog are identified by a unique ID and |
| | can only be accessed by those with the correct |
| | authorization. |
| Data | Data Packages contain data that can be sold with |
| Packages | subscription or service provision including an associated |
| | managed dataset. For example, census data will be |
| | available as a Data Package; this Data Package will |
| | enable the described solution users to interact and use a |
| | slowly changing dataset called census. (Census data can |
| | be updated after each census and is often modeled |
| | between each census). |
| Dimension | Dimensional modeling always uses the concepts of facts |
| | (sometimes referred to as measures) and dimensions. |
| | Facts are typically (but not always) numeric values that |
| | can be aggregated, and dimensions are groups of |
| | hierarchies and descriptors that define the facts. For |
| | example, sales amount is a fact; timestamp, product, |
| | register#, store#, etc. are elements of dimensions. |
| | Wikipedia^{xii} |
| Dimensional | DM is a logical design technique that seeks to present the |
| Modeling | data in a standard, intuitive framework that allows for |
| | high-performance access. It is inherently dimensional, |
| | and it adheres to a discipline that uses the relational |
| | model with some important restrictions. Every |
| | dimensional model is composed of one table with a |
| | multipart key, called the fact (sometimes referred to as |
| | measures) table, and a set of smaller tables called |
| | dimension tables. Each dimension table has a single-part |
| | primary key that corresponds exactly to one of the |
| | components of the multipart key in the fact table. |
| | Intelligent Enterprise^{xiii} |
| Enterprise | In a typical J2EE application, Enterprise JavaBeans |
| Java Beans | (EJBs) contain the application's business logic and live |
| (EJBs) | business data. Although it is possible to use standard Java |
| | objects to contain your business logic and business data, |
| | using EJBs addresses many of the issues you would find |
| | by using simple Java objects, such as scalability, lifecycle |
| | management, and state management. Wikipedia^{xiv} |
| Fact | Dimensional modeling always uses the concepts of facts |
| | (sometimes referred to as measures) and dimensions. |
| | Facts are typically (but not always) numeric values that |
| | can be aggregated, and dimensions are groups of |
| | hierarchies and descriptors that define the facts. For |
| | example, sales amount is a fact; timestamp, product, |
| | register#, store#, etc. are elements of dimensions. |
| | Wikipedia^{xv} |
| IIOP | IIOP (Internet Inter-ORB Protocol) is a protocol that |
| (Internet | makes it possible for distributed programs written in |
| Inter-ORB | different programming languages to communicate over |
| Protocol) | the Internet. SearchCIO-Midmarket^{xvi} |
| KML | Keyhole Markup Language. |
| | Google ™ Earth is a geographic browser - a powerful |
| | tool for viewing, creating and sharing interactive files |
| | containing highly visual location-specific information. |
| | These files are called KMLs (for Keyhole Markup |
| | Language): what HTML is to regular Internet browsers, |
| | KML is to geographic browsers. You can open KML files |
| | in both Google ™ Earth and Google ™ Maps, as well as in |
| | many other geographic browsers. Google ™ Maps^{xvii} |
| MDT | The average time that a system is non-operational. This |
| | includes all time associated with repair, corrective and |
| | preventive maintenance; self imposed downtime, and any |
| | logistics or administrative delays. The difference between |
| | MDT and MTTR (mean time to repair) is that MDT |
| | includes any and all delays involved; MTTR looks solely |
| | at repair time. Wikipedia^{xviii} |
| Metadata | Metadata describes how data is queried, filtered, |
| | analyzed, and displayed in the described solution. In |
| | general terms, metadata is data about data. For example, |
| | in a library the metadata (pertaining to the catalog of |
| | books) could be - the title of the book, the author(s), |
| | categories (e.g. reference, fiction, non-fiction etc), |
| | physical location. This metadata can be used in searches, |
| | directories etc to help users locate books. |
| MTBF | Mean time between failures (MTBF) is the mean |
| | (average) time between failures of a system, and is often |
| | attributed to the ‘useful life’ of the device i.e. not |
| | including ‘infant mortality’ or ‘end of life’. Calculations of |
| | MTBF assume that a system is ‘renewed’, i.e. fixed, after |
| | each failure, and then returned to service immediately |
| | after failure. The average time between failing and being |
| | returned to service is termed mean down time (MDT) or |
| | mean time to repair (MTTR). |
| | MTBF = (downtime − uptime)/number of failures. |
| | Wikipedia^{xix} |
| MTTR | Mean Time to Recovery - the average time that a device |
| | will take to recover from a non-terminal failure. |
| | Examples of such devices range from self-resetting fuses |
| | (where the MTTR would be very short, probably |
| | seconds), up to whole systems which have to be replaced. |
| | The MTTR would usually be part of a maintenance |
| | contract, where the user would pay more for a system |
| | whose MTTR was 24 hours, than for one of, say, 7 days. |
| | This does not mean the supplier is guaranteeing to have |
| | the system up and running again within 24 hours (or 7 |
| | days) of being notified of the failure. It does mean the |
| | average repair time will tend towards 24 hours (or 7 |
| | days). A more useful maintenance contract measure is the |
| | maximum time to recovery which can be easily measured |
| | and the supplier held accountable. Wikipedia^{xx} |
| OLAP | On Line Analytical Processing. |
| | OLAP performs multidimensional analysis of business |
| | data and provides the capability for complex calculations, |
| | trend analysis, and sophisticated data modeling. |
| | OLAP enables end-users to perform ad hoc analysis of |
| | data in multiple dimensions, thereby providing the insight |
| | and understanding the need for better decision making. |
| | Paris ™ Technologies^{xxi} |
| Planogram | A planogram is a diagram of fixtures and products that |
| | illustrates how and where retail products should be |
| | displayed, usually on a store shelf in order to increase |
| | customer purchases. They may also be referred to as |
| | planograms, plan-o-grams, schematics (archaic) or POGs. |
| | A planogram is often received before a product reaches a |
| | store, and is useful when a retailer wants multiple store |
| | displays to have the same look and feel. Often a consumer |
| | packaged goods manufacturer will release a new |
| | suggested planogram with their new product, to show |
| | how it relates to existing products in said category. |
| | Planograms are used nowadays in all kind of retail areas. |
| | A planogram defines which product is placed in which |
| | area of a shelving unit and with which quantity. The rules |
| | and theories for the creation of a planogram are set under |
| | the term of merchandising. Wikipedia^{xxii} |
| Request | The Request Queue manages Visual Documents requests |
| Queue | generated by a user or the scheduler. |
| | As requests are processed, the Visual Document |
| | maintains various statuses until the Visual Document is |
| | complete and available to be viewed by a user. |
| SaaS | Software as a Service. |
| | A software application delivery model where a software |
| | vendor develops a web-native software application and |
| | hosts and operates (either independently or through a |
| | third-party) the application for use by its customers over |
| | the Internet. Customers do not pay for owning the |
| | software itself but rather for using it. Wikipedia^{xxiii} |
| Scrum | Scrum is an agile process that can be used to manage and |
| | control software development. |
| | With Scrum, projects progress via a series of iterations |
| | called sprints. These iterations could be as short as 1 |
| | week or as long as 1 month. |
| | Scrum is ideally suited for projects with rapidly changing |
| | or highly emergent requirements. The work to be done on |
| | a Scrum project is listed in the Product Backlog, which is |
| | a list of all desired changes to the product. At the start of |
| | each sprint a Sprint Planning Meeting is held during |
| | which the Product Owner prioritizes the Product Backlog |
| | and the Scrum Team selects the tasks they can complete |
| | during the coming Sprint. These tasks are then moved |
| | from the Product Backlog to the Sprint Backlog. |
| | Each day during the sprint a brief daily meeting is held |
| | called the Daily Scrum, which helps the team stay on |
| | track. |
| | At the end of each sprint the team demonstrates the |
| | completed functionality at a Sprint Review Meeting. |
| Self | A type of artificial neural network that is trained using |
| Organizing | unsupervised learning to produce a low-dimensional |
| Maps (SOM) | (typically two dimensional), representation of the input |
| | space of the training samples, called a map. The map |
| | seeks to preserve the topological properties of the input |
| | space. Wikipedia^{xxiv} |
| Servlets | Servlets are modules of Java code that run in a server |
| | application (hence the name “Servlets”, similar to |
| | “Applets” on the client side) to answer client requests. |
| | Servlets are not tied to a specific client-server protocol |
| | but they are most commonly used with HTTP and the |
| | word “Servlet” is often used in the meaning of “HTTP |
| | Servlet”. |
| | Servlets make use of the Java standard extension classes. |
| | Since Servlets are written in the highly portable Java |
| | language and follow a standard framework, they provide |
| | a means to create sophisticated server extensions in a |
| | server and operating system independent way. |
| | Typical uses for HTTP Servlets include: |
| | 1. Processing and/or storing data submitted by an |
| | HTML form. |
| | 2. Providing dynamic content, e.g. returning the results |
| | of a database query to the client. |
| | 3. Managing state information on top of the stateless |
| | HTTP, e.g. for an online shopping cart system which |
| | manages shopping carts for many concurrent |
| | customers and maps every request to the right |
| | customer. |
| | Servlet Essentials^{xxv} |
| Subject | The Subject Matter Expert is that individual who exhibits |
| Matter | the highest level of expertise in performing a specialized |
| Expert | job, task, or skill within the organization. Six Sigma^{xxvi} |
| (SME) | |
| WebSphere | WebSphere is an IBM ™ brand of products that |
| | implement and extend Sun's JavaTwoEnterpriseEdition |
| | (J2EE) platform. The Java-based application and |
| | transaction infrastructure delivers high-volume |
| | transaction processing for e-business and provides |
| | enhanced capabilities for transaction management, as well |
| | as security, performance, availability, connectivity, and |
| | scalability. IBM ™ WebSphere Product Pages^{xxvii} |

### Further Embodiments

It will be understood that the embodiments of the present invention described herein are by way of example only, and that various changes and modifications may be made without departing from the scope of invention.

It will be understood that any reference to displaying a visual representation on a screen equally applies to storing that representation or printing the representation onto any suitable medium. As explained above, the data used to display, store or print may be adjusted by the system according to the purpose of the data.

Further, it will be understood that any references in this document to any modules, engines or associated processing, analysis, determination, or other steps, may be implemented in any form. For example, the modules or engines may be implemented, and the associated steps may be carried out, using hardware, firmware or software.

### DOCUMENT REFERENCES

ⁱ Wikipedia; “Heat map”; Date Accessed, Jun. 10, 2008; http://en.wikipedia.org/wiki/Heat_map
ⁱⁱ Nasdaq; Nasdaq-100 Dynamic Heatmap; Date Accessed, Jun. 10, 2008; http://screening.nasdaq.com/heatmaps/heatmap_{—}100. asp
ⁱⁱⁱ Weather.com; Date Accessed, Jan. 31, 2008; http://weather.com/.
^{iv} Information Aesthetics; Information Aesthetics; “travel time maps”; Date Accessed, Jan. 31, 2008; http://infosthetics.com/archives/locative/v
^{V} Few, Stephen—from white paper “BizViz: The Power of Visual Business Intelligence”—Mar. 7, 2006. www.perceptualedge.com
^{vi} Wikipedia; Wikipedia; “Voronoi Diagram”; Date Accessed, Jan. 31, 2008; http://en.wikipedia.org/wiki/Voronoi_diagram.
^{vii} ENTROPÍA; ENTROPÍA; “Más tiempo”; Date Accessed, Jan. 31, 2008; http://www.luispabon.com/entropia/index.php?entry=entry071129-145959.
^{viii} Byron, Lee; Lee Byron Megamu; “What have I been listening to?”; Date Accessed, Jan. 31, 2008; http://www.megamu.com/lastfm.
^{ix} ENTROPÍA; ENTROPÍA; “Más tiempo”; Date Accessed, Jan. 31, 2008; http://www.luispabon.com/entropia/index.php?entry=entry071129-145959.
^{x} Wikipedia; Wikipedia; “Julian Day”; Date Accessed, Jan. 30, 2008; Reference http://en.wikipedia.org/wiki/Julian_day.
^{xi} Wikipedia; Wikipedia; “Agile Software Development”; Date Accessed, Jan. 30, 2008; http://en.wikipedia.org/wiki/Agile_software_development
^{xii} Wikipedia; Wikipedia: “Dimensional Modeling”; Date Accessed: Apr. 10, 2008; http://en.wikipedia.org/wiki/Dimensional_modeling
^{xiii} Kimball, Ralph, A Dimensional Modeling Manifesto; Date Accessed: Apr. 10, 2008; http://www.dbmsmag.com/9708d15.html
^{xiv} Sam's Publishing; developer.com Gamelan™; “Introduction to EJB's”; http://www.developer.com/java/ejb/article.php/1434371.
^{xv} Wikipedia; Wikipedia: “Dimensional Modeling”; Date Accessed: Apr. 10, 2008; http://en.wikipedia.org/wiki/Dimnensional_modeling
^{xvi} Gilbert, Cheryl, et. al.; SearchCIO—Midmarket; “IIOP”; date Accessed, Jan. 30, 2008; http://searchcio-midmarket.techtarget.com/sDefinition/0,,sid183_gci214019,00.html.
^{xvii} Google; Google Maps; “KML Gallery: Explore the Earth on Google”; Date Accessed, Jan. 30, 2008; http://earth.google.com/gallery/
^{xviii} Wikipedia; Wikipedia; “Mean_down_time”; Date Accessed, Jan. 30, 2008; http://en.wikipedia.org/wiki/Mean_down_time.
^{xix} Wikipedia; Wikipedia; “Mean time_between_failures”; Date Accessed, Jan. 30, 2008; http://en.wikipedia.org/wiki/Mean_time_between_failures.
^{xx} Wikipedia; Wikipedia; “Mean time to recovery”; Date Accessed, Jan. 30, 2008; http://en.wikipedia.org/wiki/Mean_time_to_recovery.
^{xxi} Paris Technologies, Inc.; Paris Technologies; “OLAP”; Date Accessed, Jan. 30, 2008; http://www.olap.com.
^{xxii} Wikipedia; Wikipedia; “Planogram”; Date Accessed, Jan. 30, 2008; http://en.wikipedia.org/wiki/Planogram.
^{xxiii} Wikipedia; Wikipedia; “Software as a Service”; Date Accessed, Jan. 30, 2008; http://en.wikipedia.org/wiki/Software_as_a_Service.
^{xxiv} Wikipedia; Wikipedia; “Self-organizing map”; Date Accessed, Jan. 30, 2008; http://en.wikipedia.org/wiki/Self-organizing_map.
^{xxv} Zeiger, Stefan, Servlet Essentials, Version 1.3.6—Nov. 4, 1999; Date Accessed, Jan. 30, 2008
^{xxvi} Six Sigma; Subject Matter Expert_SME; Date Accessed: Jan. 30, 2008; http://www.isixsigma.com/dictionary/Subject_Matter_Expert_-_SME-396.htm
^{xxvii} IBM; WebSphere Product Pages; “WebSphere software”; Date Accessed: Jan. 30, 2008; http://www-306.ibm.com/software/websphere/?pge1=ibmhzn&cm_re=masthead-_-products-_-sw-websphere.

1.-93. (canceled)

94. In a graphical analysis computing system, a method of arranging data sets for graphical analysis, wherein at least two of the data sets have different periodicities, the method comprising the steps of:
a. a data retrieval module retrieving data from a data storage module in communication with the graphical analysis computing system;
b. a periodicity determination module determining a plurality of periodicities within the retrieved data to identify a plurality of data sets based on the determined periodicities; and
c. an alignment module distorting a first identified data set of a first periodicity so that it maps onto a single undistorted identified data set of a second periodicity, wherein the second periodicity is different to the first periodicity.

95. The method of claim 94 further including the step of distorting a plurality of first identified data sets relative to the second identified data set.

97. The method of claim 94, wherein step c) further includes the step of aligning a start period of the first identified data set with the start period of the second identified data set.

96. The method of claim 94, wherein step c) further includes the step of aligning an end period of the first identified data set with an end period of the second identified data set.

98. The method of claim 94, wherein step c) further includes the step of determining whether the first identified data set is wholly encompassed within the second identified data set.

99. The method of claim 98, whereupon a negative determination, the method further includes the step of distorting the first identified data set so that it is wholly encompassed within the second identified data set.

100. The method of claim 94, wherein step c) further includes the step of modifying the first identified data set so that it aligns with the second identified data set.

101. The method of claim 100, further including the step of restricting the first identified data set so that it aligns with the second identified data set.

102. The method of claim 100, further including the step of expanding the first identified data set so that it aligns with the second identified data set.

103. The method of claim 100, further including the step of analyzing the modified first identified data set.

104. The method of claim 100, further including the step of replacing the first identified data set with the modified first identified data set.

105. The method of claim 94 wherein the periodicity is time related.

106. The method of claim 94 wherein the periodicity is calendar related.

107. The method of claim 94, wherein a lowest common time base is determined from the determined periodicities, and the first identified data set is based on the determined lowest common time base.

108. The method of claim 94, wherein the distortion of the first identified data set includes the step of arranging the graphical representation of the first identified data set so that it aligns with a spatial area allocated for the graphical representation of the second identified data set.

109. The method of claim 108, further including the step of condensing the graphical representation of the first identified data set so that it aligns with the spatial area.

110. The method of claim 108, further including the step of expanding the graphical representation of the first identified data set so that it aligns with the spatial area.

111. The method of claim 108, further including the step of moving the graphical representation of the first identified data set so that it aligns with the spatial area.

112. The method of claim 108, wherein the spatial area is at least a portion of a dodecagon spiral.

113. The method of claim 108, wherein the spatial area is at least a portion of a box spiral.

114. The method of claim 108, wherein the first and second identified data sets are displayed hierarchically.
information associated with how the first and second data sets are aligned.

115. The method of claim 94, wherein a graphical representation of the first identified data set is distorted to align it to the determined periodicity of the second identified data set.

116. The method of claim 115, wherein the degree of distortion is increased as the graphical representation of the first identified data set is viewed at increased granularity.

117. A method as claimed in claim 94, wherein a graphical representation of the first identified data set can be viewed at increasing granularity, and the method includes the further steps of:
identifying a further data set at the increased granularity, wherein the further data set is based on a further periodicity different to the first and second periodicities; and
distorting the further identified data set relative to the second identified data set.

118. In a graphical analysis computing system, a method of arranging, for graphical analysis, periodic data sets including periodic events, the method comprising the steps of:
a. a data retrieval module retrieving data from a data storage module in communication with the graphical analysis computing system;
b. a periodicity determination module determining periodicities within the retrieved data;
c. identifying a plurality of data sets based on the determined periodicities; and
d. identifying an instance of a periodic event within two or more identified data sets; and
e. an alignment module distorting one, or both, of data and its graphical representation associated with at least one of the identified data sets to map a first identified data set of a first periodicity onto a single undistorted identified data set of a second periodicity and align the identified periodic event instances relative to each other.

119. The method of claim 118, wherein one or both of the data and its graphical representation is distorted in only one of the identified data sets

120. The method of claim 118, wherein the determined periodicity is a period of time selected from a multiple, whole or portion of a second, minute, hour, day, week, month, or year.

121. The method of claim 118, wherein the determined periodicity is a multiple, whole or portion of a calendar period.

122. The method of claim 118, wherein the determined periodicity is a multiple, whole or portion of a social or business period.

123. The method of claim 118 further including the steps of:
the periodicity determination module identifying a first instance of the periodic event within a first data set within a first group of data sets having a first periodicity,
identifying a second instance of the periodic event within a second data set within a second group of data sets having a first periodicity, and
determining whether the first data set is in a same or different relative position within the first group to the position of the second data set in the second group, and
the alignment module aligning one or both of the data and its graphical representation associated with the first and second instances of the periodic event according to the position determination.

124. The method of claim 123, whereupon the determination that the first data set is in a different relative position, the method further includes the steps of:
the alignment module aligning the first data set in the first group with the second data set within the second group, and
aligning the data associated with the first instance of the periodic event in the first data set with the data associated with the second instance of the periodic event in the second data set.

125. The method of claim 123, whereupon the determination that the first data set is in the same relative position, the method further includes the step of: the alignment module aligning the data associated with the first instance of the periodic event in the first data set with the data associated with the second instance of the periodic event in the second data set.

126. The method of claim 123, further including the step of the alignment module modifying the data within the first data set associated with the first instance to align the first and second instances of the periodic event.

127. The method of claim 126, further including the step of the alignment module restricting at least a portion of the data within the first data set so that the first instance of the periodic event aligns with the second instance of the periodic event.

128. The method of claim 126, further including the step of the alignment module expanding at least a portion of the data within the first data set so that the first instance of the periodic event aligns with the second instance of the periodic event.

129. The method of claim 126, further including the step of replacing the first data set with the modified first data set.

130. The method of claim 118, wherein the alignment of the first data set includes the step of distorting the graphical representation of the first instance of the periodic event so that it aligns with the graphical representation of the second instance of the periodic event.

131. The method of claim 130, further including the step of condensing the graphical representation of the first data set so that the first instance of the periodic event aligns with the second instance of the periodic event.
data set to provide a condensed graphical representation of the first data set.

132. The method of claim 130, further including the step of expanding the graphical representation of the first data set so that the first instance of the periodic event aligns with the second instance of the periodic event.

133. The method of claim 130, further including the step of moving at least a portion of the graphical representation of the first data set so that the first instance of the periodic event aligns with the second instance of the periodic event.

134. The method of claim 130, wherein the graphical representation is a dodecagon spiral.

135. The method of claim 130, wherein the graphical representation is a box spiral.

136. The method of claim 130, wherein the data sets are displayed in the form representing two or more calendar systems.

137. The method of claim 130, wherein the first and second data sets are displayed hierarchically.

138. The method of claim 130 herein the degree of distortion is increased as the graphical representation of the first data set is viewed at increased granularity.

139. In a temporal query system, a method of constructing queries against a plurality of data sets having different periodicities comprising:
a. a determination module determining the periodicity of the plurality of data sets;
b. a query resolving module resolving the temporal parameters passed in the query; and
c. a data set creation module creating data sets according to the resolved parameters by mapping a first identified data set of a first periodicity onto a single undistorted identified data set of a second periodicity.

140. A method as claimed in claim 139 where the input parameters are times in different time zones.

141. A method as claimed in claim 139 where the calculations of temporal or relationships functions are built on an extension of SQL.

142. A method as claimed in claim 139 where the calculations or temporal functions or relationships use metadata to provide sensible defaults for the interpretation of results.

143. A method as claimed in claim 139 where a rules engine in communication with the query resolving module is used to resolve queries giving an answer that is most likely to be correct based on a set of rules applied to the engine.

144. A method as claimed in claim 139 where the implementation of the query results is produced as a result of an extended SQL query against an extended relational database.

145. A graphical analysis computing system for arranging data sets for graphical analysis, wherein at least two of the data sets have different periodicities, the system comprising
a data retrieval module arranged to retrieve data from a data storage module in communication with the graphical analysis computing system;
a periodicity determination module arranged to determine a plurality of periodicities within the retrieved data to identify a plurality of data sets based on the determined periodicities; and
an alignment module arranged to distort a first identified data set of a first periodicity so that it maps onto a single undistorted identified data set of a second periodicity, wherein the second periodicity is different to the first periodicity.

146. A graphical analysis computing system for arranging, for graphical analysis, periodic data sets including periodic events, the system comprising
a data retrieval module arranged to retrieve data from a data storage module in communication with the graphical analysis computing system;
a periodicity determination module arranged to determine periodicities within the retrieved data; identify a plurality of data sets based on the determined periodicities; and
identify an instance of a periodic event within two or more identified data sets; and
an alignment module arranged to distort one, or both, of data and its graphical representation associated with at least one of the identified data sets to map a first identified data set of a first periodicity onto a single undistorted identified data set of a second periodicity and align the identified periodic event instances relative to each other.

147. The system of claim 146, wherein the periodicity determination module is further arranged to
identify a first instance of the periodic event within a first data set within a first group of data sets having a first periodicity,
identify a second instance of the periodic event within a second data set within a second group of data sets having a first periodicity, and
determine whether the first data set is in a same or different relative position within the first group to the position of the second data set in the second group, and the alignment module is further arranged to align one or both of the data and its graphical representation associated with the first and second instances of the periodic event according to the position determination output by the periodicity determination module.

148. A temporal query system for constructing queries against data sets having different periodicities, the system comprising
a determination module arranged to determine the periodicity of the data sets,
a query resolving module arranged to resolve the temporal parameters passed in the query; and
a data set creation module arranged to create data sets according to the resolved parameters by mapping a first identified data set of a first periodicity onto a single undistorted identified data set of a second periodicity.
